(19) United States
(12) Patent Application Publication
(10) Pub. No.: US 2023/0327185 A1
(43) Pub. Date: Oct. 12, 2023

(54) SOLID ION CONDUCTOR, SOLID ELECTROLYTE COMPRISING SAME, MANUFACTURING METHOD THEREFOR, AND ELECTROCHEMICAL CELL COMPRISING SAME

(71) Applicant: SAMSUNG SDI CO., LTD., Yongin-si, Gyeonggi-do (KR)

(72) Inventors: Saebom RYU, Suwon-si, Gyeonggi-do (KR); Youngsin PARK, Suwon-si, Gyeonggi-do (KR)

(21) Appl. No.: 18/013,288

(22) PCT Filed: Dec. 10, 2021
(86) PCT No.: PCT/KR2021/018794

§ 371 Date: Jun. 28, 2023

(30) Foreign Application Priority Data
Dec. 15, 2020 (KR) 10-2020-0175836

(51) Int. Cl. H01M 10/0562; H01M 4/04; H01M 4/583; H01M 4/40; H01M 4/36

(52) U.S. Cl. CPC H01M 10/0562; H01M 4/0404; H01M 2004/027; H01M 4/405; H01M 4/366; H01M 4/583

(57) ABSTRACT

Provided are a solid ion conductor represented by Formula 1 and having an argyrodite crystal structure, and a solid electrolyte and an electrochemical cell that include the solid ion conductor:

Li_{7-2a-b-c}MₐPS_{6-a-b-c}OₐX1_{b}X2_{c} Formula 1

wherein, in Formula 1, M is zinc (Zn), cadmium (Cd), mercury (Hg), or a combination thereof,

X1 and X2 are each independently chlorine (Cl), bromine (Br), iodine (I), a pseudohalogen, or a combination thereof, and

conditions of 0<a<0.5, 0<b<2, 0<c<2, and 1<b+c<3 are satisfied.

### TECHNICAL FIELD

The present disclosure relates to a solid ion conductor, a solid electrolyte including the same, a method of preparing the same, and an electrochemical cell including the same.

### BACKGROUND ART

Recently, the development of batteries with high energy density and safety has been actively carried out in response to industrial demands. For example, lithium-ion batteries are being put to practical use not only in the fields of information-related devices and communication devices, but also in the fields of automobiles. In the fields of automobiles, safety is especially considered important as it is related to human life.

Lithium-ion batteries currently available on the market use a liquid electrolyte containing a flammable organic solvent, and thus overheating and fire may occur in the case of a short circuit. In this regard, all-solid batteries using a solid electrolyte instead of an electrolytic solution are being proposed.

All-solid batteries do not use a flammable organic solvent, and thus the possibility of fire or explosion may be greatly reduced even in the case of a short circuit. Therefore, such all-solid batteries may have significantly increased stability compared to lithium-ion batteries using an electrolytic solution.

All-solid batteries may use, as an electrolyte, a sulfide-based solid electrolyte having excellent ionic conductivity.

However, the sulfide-based solid electrolyte is highly reactive with moisture, and when in contact with moisture, toxic gases such as hydrogen sulfide may be generated and ionic conductivity may be reduced. In addition, sulfide-based electrolytes in the art do not have sufficient ductility and oxidation stability, and thus fail to reach charge/discharge characteristics to a satisfactory level when applied to batteries, and thus improvement thereof is required.

### DESCRIPTION OF EMBODIMENTS

### Technical Problem

One aspect is to provide a solid ion conductor having excellent ionic conductivity as well as improved moisture stability.

Another aspect is to provide a solid electrolyte including the solid ion conductor.

Another aspect is to provide an electrochemical cell including the solid ion conductor.

Another aspect is to provide a method of preparing the solid ion conductor.

### Solution to Problem

According to one aspect, provided is a solid ion conductor represented by

Formula 1 and having an argyrodite crystal structure:

Li7-2a-b-cMaPS6-a-b-cOaX1bX2c Formula 1

wherein, in Formula 1, M may be zinc (Zn), cadmium (Cd), mercury (Hg), or a combination thereof,

X1 and X2 may each independently be chlorine (Cl), bromine (Br), iodine (I), a pseudohalogen, or a combination thereof, and

conditions of 0<a<0.5, 0<b<2, 0<c<2, and 1<b+c<3 may be satisfied.

According to another aspect, provided is a solid electrolyte including the solid ion conductor.

According to another aspect, provided is an electrochemical cell including: a positive electrode layer including a positive electrode active material layer; a negative electrode layer including a negative electrode active material layer; and an electrolyte layer disposed between the positive electrode layer and the negative electrode layer; and the solid ion conductor.

According to another aspect, provided is a method of preparing the solid ion conductor, the method including: providing a mixture by bringing a lithium precursor, a metal (M) precursor, a phosphorus (P) precursor, and a halogen precursor into contact with each other; and

providing a solid ion conductor by performing heat treatment on the mixture in an inert atmosphere, to thereby prepare the aforementioned solid ion conductor.

### ADVANTAGEOUS EFFECTS OF DISCLOSURE

According to one aspect, a solid ion conductor having improvements in moisture stability, lithium-ion conductivity, lithium metal stability and oxidation stability, and material storability and processability in preparation is provided. By including the solid ion conductor, an electrochemical cell having high density and improvements in charge/discharge characteristics, high-voltage stability, and an ionic conductivity retention rate may be prepared.

### BRIEF DESCRIPTION OF DRAWINGS

FIG. 1A shows an XRD spectrum obtained before and after heat treatment for a solid ion conductor prepared according to Example 1.

FIG. 1B shows XRD spectra of solid ion conductors prepared according to

Example 2 and Comparative Examples 3, 6, and 7.

FIGS. 2A and 2B show scanning electron microscope images of a solid ion conductor prepared according to Example 1, before and after pulverization.

FIG. 2C shows a particle size distribution of a solid ion conductor prepared according to Example 1, before and after pulverization.

FIG. 3 is a graph showing changes in amounts of H₂S generated in the atmosphere by solid ion conductors prepared according to Example 2 and Comparative Examples 1, 3, 5, 6, and 7.

FIG. 4 is a graph showing changes in ionic conductivity when exposed to a dry room environment in solid ion conductors prepared Example 2 and Comparative Example 1.

FIG. 5 shows results of analyzing lithium electrodeposition/dissolution behavior in a Li/Li symmetry cell by using solid ion conductors of Examples 2 and 3 and Comparative Examples 1 and 2.

FIG. 6 shows charge/discharge characteristics of a torque cell using a solid ion conductor of each of Example 2 and Comparative Example 1.

FIGS. 7A and 7B show charge/discharge characteristics of a torque cell using a solid ion conductor of each of Example 2 and Comparative Example 1.

FIG. 8 is a schematic view of an all-solid battery according to an embodiment.

FIG. 9 is a schematic view of an all-solid battery according to another embodiment.

FIG. 10 is a schematic view of an all-solid battery according to another embodiment.

### DESCRIPTION OF EMBODIMENTS

### Technical Problem

Hereinafter, a solid ion conductor according to one or more exemplary embodiments, a solid electrolyte including the same, an electrochemical cell including the same, and a method of preparing the solid ion conductor will be described in more detail.

A solid ion conductor according to an embodiment may be represented by

Formula 1 and have an argyrodite crystal structure:

Li7-2a-b-cMaPS6-a-b-cOaX1bX2c Formula 1

wherein, in Formula 1, M may be zinc (Zn), cadmium (Cd), mercury (Hg), or a combination thereof,

X1 and X2 may each independently be chlorine (Cl), bromine (Br), iodine (I), a pseudohalogen, or a combination thereof, and

conditions of 0<a<0.5, 0<b<2, 0<c<2, and 1<b+c<3 may be satisfied.

The term “pseudohalogen” in the present specification refers to a molecule consisting of two or more electronegative atoms resembling halogens in a free state, and produces anions similar to halide ions. Examples of the pseudohalogen may include cyanide (CN), cyanate (OCN), thiocyanate (SCN), azide (N₃), or a combination thereof.

In an embodiment, M in Formula 1 may substitute a part of Li in the crystal. In addition, oxygen, X1, and X2 may substitute a part of the element S in the crystal.

In one or more embodiments, M may substitute a part of P in the crystal.

M may include, as a main component, the aforementioned element, such as Zn, Cd, Hg, or a combination thereof, and may further include, as a minor component, one or more elements selected from copper (Cu), sodium (Na), potassium (K), calcium (Ca), iron (Fe), magnesium (Mg), silver (Ag), and zirconium (Zr). Here, the minor component may substitute a portion of M, and the amount thereof may be controlled to maintain the charge balance of the solid ion conductor neutral.

The compound represented by Formula 1 may be a crystalline compound having an argyrodite-type crystal structure, and may have moisture stability improved by introducing M and oxygen into the crystal structure. For example, the solid ion conductor may include zinc as M, and oxygen substituting a part of sulfur. These components have the moisture-trapping characteristics. Thus, the solid ion conductor according to an embodiment may have excellent moisture stability so that structural collapse of the compound in the air may be suppressed, thereby improving storage properties and processability. In addition, when a part of Li is substituted with M which is an element having a larger particle diameter than Li and a part of S is substituted with two or more types of the halogen element, X1 and X2, the disorder of the halogen element increases, and thus the ionic conductivity and softness of the solid ion conductor may be improved.

When a part of Li in the crystal structure is substituted with M, which is an element having a larger ion radius than Li, such as Zn, the crystal lattice volume may increase so that the resistance against the movement of Li ions in the crystal may decrease, and when the element S (oxidation number: −2) in the crystal is substituted with the halogen element (oxidation number: −1), the ratio of Li ions that can move in the crystal may increase so that the lithium ionic conductivity of the solid ion conductor may be improved.

The argyrodite-type solid electrolyte of Li₆PS₅Cl in the related art has high reactivity with moisture so that toxic gases such as hydrogen sulfide are generated during preparation and storage processes of a material, and has poor contact with materials for forming active material layers, resulting in generation of an empty space in an active material layer, and such an empty space may serve as a resistance layer against the movement of Li ions, thereby degrading the ionic conductivity. In addition, such a solid electrolyte does not have mechanical properties sufficiently good enough to be applied to a positive electrode, resulting in poor interfacial properties with an active material, and accordingly degrading the charge/discharge characteristics.

In this regard, to solve the problems above, the inventors of the present disclosure use the compound represented by Formula 1 in which M is substituted for Li and oxygen and two types of the halogen element, X1 and X2 are introduced, so that the moisture stability is improved and the softness is increased, and thus the contact with materials for forming active material layers is also improved, thereby preparing a dense active material layer. Accordingly, due to the improvements in the lithium-ion conductivity and the lifespan characteristics and the substitution of oxygen and the halogen elements, X1 and X2, for a part of S, the amount of harmful H2S gas generated in the air may be reduced.

In Formula 1, a condition of 0.02≤a≤0.1 may be satisfied.

X1_{b}X2_{c} may be Cl_{b}Br_{c} or Cl_{b}I_{c}, and conditions of 0<b<2, 0<c<2, 1<b+c<3, and b>c may be satisfied.

In Formula 1, b may be 1.0 to 1.5 or 1.2 to 1.4, and c may be 0.1 to 0.7, 0.2 to 0.6, or 0.1 to 0.3.

In one or more embodiments, a condition of 1<b+c<2, 1.1≤b+c≤1.8, 1.2≤b+c≤1.7, or 1.2≤b+c≤1.6 may be satisfied.

In an embodiment, a condition of 1≤b/c≤50 or 1≤b/c≤20 may be satisfied.

In one or more embodiments, M may be Zn, and conditions of 0.02≤a≤0.1, 1<b+c<2, b>c, and 1≤b/c≤20 may be satisfied.

The compound represented by Formula 1 may be represented by Formula 2:

Li7-2a-b-cZnaPS6-a-b-cOaClbBrc Formula 2

wherein, in Formula 2, conditions of 0<a<0.5, 0<b<2, 0<c<1, and 1<b+c<2 may be satisfied.

In Formula 2, conditions of b>c and 1≤b/c≤50 may be satisfied.

In Formula 2, b may be 1.0 to 1.5, 1.1 to 1.5, 1.1 to 1.4, or 1.2 to 1.4, and c may be 0.01 to 0.7, 0.1 to 0.7, 0.2 to 0.6, or 0.2 to 0.4.

In one or more embodiments, a condition of 1<b+c<2, 1.1≤b+c≤1.8, 1.2≤b+c≤1.7, or 1.2≤b+c≤1.6 may be satisfied.

In an embodiment, in the solid ion conductor, a ratio of a peak intensity (I_{B}) at a diffraction angle (2θ)=29.07±0.5° to a peak intensity (I_{A}) at a diffraction angle (2θ)=30.09°±0.5°, i.e., I_{B}/I_{A}, in an X-ray diffraction (XRD) spectrum using CuKα rays may satisfy a condition of I_{B}/I_{A}<0.1 or I_{B}/I_{A}≤0.07.

Here, I_{A} indicates the intensity of a main peak A of the argyrodite-type crystal, and the I_{B} indicates the intensity of an impurity peak B of the argyrodite-type crystal. The peak A refers to the main peak having the greatest intensity among peaks related to the argyrodite, and the peak B refers to the peak having the greatest intensity among peaks other than the peaks related to the argyrodite. The condition of I_{B}/I_{A}<0.1 refers that the intensity (I_{B}) of the peak B to the intensity (I_{A}) of the peak A is less than 10%.

In the case of I_{B}/I_{A}<0.1, the solid ion conductor have improved ionic conductivity, whereas, in the case of I_{B}/I_{A}≤0.1, impurities act as a resistance to the movement of Li ions so that the lithium-ion conductivity of the solid ion conductor may be degraded.

The solid ion conductor may be Li_{5.36}Zn_{0.02}PS_{4.38}O_{0.02}Cl_{1.4}Br_{0.2}, Li_{5.3}Zn_{0.05}PS_{4.35}O_{0.05}Cl_{1.4}Br_{0.2}, Li_{5.2}Zn_{0.1}PS_{4.3}O_{0.1}Cl_{1.4}Br_{0.2}, Li_{5.36}Zn_{0.02}PS_{4.38}O_{0.02}Cl_{1.2}Br_{0.4}, Li_{5.3}Zn_{0.05}PS_{4.35}_{0.05}Cl_{1.2}Br_{0.4}, Li_{5.2}Zn_{0.1}PS_{4.3}O_{0.1}Cl_{1.2}Br_{0.4}, Li_{5.36}Zn_{0.02}PS_{4.38}O_{0.02}Cl_{1.3}Br_{0.3,} Li_{5.3}Zn_{0.05}PS_{4.35}O_{0.05}Cl_{1.3}Br_{0.3}, Li_{5.2}Zn_{0.1}PS_{4.3}O_{0.1}Cl_{1.3}Br_{0.3}, Li_{5.36}Zn_{0.02}PS_{4.38}O_{0.02}Cl_{1.24}Br_{0.36}, Li_{5.3}Zn_{0.05}PS_{4.35}O_{0.05}Cl_{1.24}Br_{0.36}, Li_{5.2}Zn_{0.1}PS_{4.3}O_{0.1}Cl_{1.24}Br_{0.36}, Li_{5.36}Zn_{0.02}PS_{4.38}O_{0.02}Cl_{1.46}Br_{0.14}, Li_{5.3}Zn_{0.05}PS_{4.35}O_{0.05}Cl_{1.46}Br_{0.14}, Li_{5.2}Zn_{0.1}PS_{4.3}O_{0.1}Cl_{1.46}Br_{0.14}, Li_{5.36}Zn_{0.02}PS_{4.38}O_{0.02}Cl_{1.52}Br_{0.08}, Li_{5.3}Zn_{0.05}PS_{4.35}O_{0.05}Cl_{1.52}Br_{0.08}, Li_{5.2}Zn_{0.1}PS_{4.3}O_{0.1}Cl_{1.52}Br_{0.08}, Li_{5.26}Zn_{0.07}PS_{4.33}O_{0.07}Cl_{1.4}Br_{0.2}, Li_{5.56}Zn_{0.02}PS_{4.58}O_{0.02}Cl_{1.2}Br_{0.2}, Li_{5.5}Zn_{0.05}PS_{4.55}O_{0.05}Cl_{1.2}Br_{0.2}, Li_{5.46}Zn_{0.07}PS_{4.53}O_{0.07}Cl_{1.2}Br_{0.2}, Li_{5.4}Zn_{0.1}PS_{4.5}O_{0.1}Cl_{1.2}Br_{0.2}, Li_{5.66}Zn_{0.02}PS_{4.68}O_{0.02}Cl_{1.2}Br_{0.1}, Li_{5.6}Zn_{0.05}PS_{4.65}O_{0.05}Cl_{1.2}Br_{0.1}, Li_{5.56}Zn_{0.07}PS_{4.63}O_{0.07}Cl_{1.2}Br_{0.1}, Li_{5.5}Zn_{0.1}PS_{4.6}O_{0.1}Cl_{1.2}Br_{0.1}, Li_{5.76}Zn_{0.02}PS_{4.78}O_{0.02}Cl_{1.0}Br_{0.2}, Li_{5.7}Zn_{0.05}PS_{4.75}O_{0.05}Cl_{1.0}Br_{0.2}, Li_{5.66}Zn_{0.07}PS_{4.73}O_{0.07}Cl_{1.0}Br_{0.2}, Li_{5.6}Zn_{0.1}PS_{4.7}O_{0.1}Cl_{1.0}Br_{0.2}, Li_{5.36}Cd_{0.02}PS_{4.38}O_{0.02}Cl_{1.4}Br_{0.2}, Li_{5.3}Cd_{0.05}PS_{4.35}O_{0.05}Cl_{1.4}Br_{0.2}, Li_{5.2}Cd_{0.1}PS_{4.3}O_{0.1}Cl_{1.4}Br_{0.2}, Li_{5.36}Cd_{0.02}PS_{4.38}O_{0.02}Cl_{1.2}Br_{0.4}, Li_{5.3}Cd_{0.05}PS_{4.35}O_{0.05}Cl_{1.2}Br_{0.4}, Li_{5.2}Cd_{0.1}PS_{4.3}O_{0.1}Cl_{1.2}Br_{0.4}, Li_{5.36}Cd_{0.02}PS_{4.38}O_{0.02}Cl_{1.3}Br_{0.3}, Li_{5.3}Cd_{0.05}PS_{4.35}O_{0.05}Cl_{1.3}Br_{0.3}, Li_{5.2}Cd_{0.1}PS_{4.3}O_{0.1}Cl_{1.3}Br_{0.3}, Li_{5.36}Cd_{0.02}PS_{4.38}O_{0.02}Cl_{1.24}Br_{0.36,} Li_{5.3}Cd_{0.05}PS_{4.35}O_{0.05}Cl_{1.24}Br_{0.36}, Li_{5.2}Cd_{0.1}PS_{4.3}O_{0.1}Cl_{1.24}Br_{0.36}, Li_{5.36}Cd_{0.02}PS_{4.38}O_{0.02}Cl_{1.46}Br_{0.14}, Li_{5.3}Cd_{0.05}PS_{4.35}O_{0.05}Cl_{1.46}Br_{0.14}, Li_{5.2}Cd_{0.1}PS_{4.3}O_{0.1}Cl_{1.46}Br_{0.14}, Li_{5.36}Cd_{0.02}PS_{4.38}O_{0.02}Cl_{1.52}Br_{0.08}, Li_{5.3}Cd_{0.05}PS_{4.35}O_{0.05}Cl_{1.52}Br_{0.08}, Li_{5.2}Cd_{0.1}PS_{4.3}O_{0.1}Cl_{1.52}Br_{0.08}, Li_{5.36}Hg_{0.02}PS_{4.38}O_{0.02}Cl_{1.4}Br_{0.2}, Li_{5.3}Hg_{0.05}PS_{4.35}O_{0.05}Cl_{1.4}Br_{0.2}, Li_{5.2}Hg_{0.1}PS_{4.3}O_{0.1}Cl_{1.4}Br_{0.2}, Li_{5.36}Hg_{0.02}PS_{4.38}O_{0.02}Cl_{1.2}Br_{0.4}, Li_{5.3}Hg_{0.05}PS_{4.35}O_{0.05}Cl_{1.2}Br_{0.4}, Li_{5.2}Hg_{0.1}PS_{4.3}O_{0.1}Cl_{1.2}Br_{0.4}, Li_{5.36}Hg_{0.02}PS_{4.38}O_{0.02}Cl_{1.3}Br_{0.3}, Li_{5.3}Hg_{0.05}PS_{4.35}O_{0.05}Cl_{1.3}Br_{0.3}, Li_{5.2}Hg_{0.1}PS_{4.3}O_{0.1}Cl_{1.3}Br_{0.3}, Li_{5.36}Hg_{0.02}PS_{4.38}O_{0.02}Cl_{1.24}Br_{0.36}, Li_{5.3}Hg_{0.05}PS_{4.35}O_{0.05}Cl_{1.24}Br_{0.36}, Li_{5.2}Hg_{0.1}PS_{4.3}O_{0.1}Cl_{1.24}Br_{0.36}, Li_{5.36}Hg_{0.02}PS_{4.38}O_{0.02}Cl_{1.46}Br_{0.14}, Li_{5.3}Hg_{0.05}PS_{4.35}O_{0.05}Cl_{1.46}Br_{0.14}, Li_{5.2}Hg_{0.1}PS_{4.3}O_{0.1}Cl_{1.46}Br_{0.14}, Li_{5.36}Hg_{0.02}PS_{4.38}O_{0.02}Cl_{1.52}Br_{0.08}, Li_{5.3}Hg_{0.05}PS_{4.35}O_{0.05}Cl_{1.52}Br_{0.08}, Li_{5.2}Hg_{0.1}PS_{4.3}O_{0.1}Cl_{1.52}Br_{0.08}, or a combination thereof

The ionic conductivity of the solid ion conductor at 25° C. may be 3.0 mS/cm or more or in a range of 3.4 mS/cm to 8.0 mS/cm, 4.0 mS/cm to 8.0 mS/cm, or 4.5 mS/cm to 8.0 mS/cm.

In an embodiment, the solid ion conductor may have a ratio (pellet density/powder density) of pellet density to powder density of 85% or more. Here, the pellet density is obtained by measuring density after preparing powders of the solid ion conductor into pellets and pressing the pellets with a force of 4 tons/cm2 for 2 minutes, and the powder density is obtained by calculation according to the density functional theory known in the art.

In addition, the solid ion conductor may have an ionic conductivity retention rate of 70% or more, 80% or more, 81% or more, or 81% to 95%, after 10 days under dry conditions in the air having a dew point of less than −60° C. In addition, the amount of H₂S generated when exposed to the atmosphere may be less than 5.5 cm³/g, less than 5.0 cm³/g, or 0.5 cm³/g to 4.5 cm³/g. Here, the atmosphere refers to a condition of a temperature of 21° C. and a relative humidity of 63%.

A solid electrolyte according to another embodiment may include the solid ion conductor represented by Formula 1. When the solid electrolyte includes the aforementioned solid ion conductor, the solid electrolyte may have high ionic conductivity, high chemical stability, and an effect of reducing the emission of harmful H2S gas. The solid electrolyte including the solid ion conductor represented by Formula 1 may have improved stability against the air as well as the electrochemical stability against the lithium metal. Therefore, the solid ion conductor represented by Formula 1 may be used, for example, as a solid electrolyte of an electrochemical cell.

The solid electrolyte may additionally include, in addition to the solid ion conductor represented by Formula 1, a general solid electrolyte in the art. For example, a general sulfide-based solid electrolyte and/or a general oxide-based solid electrolyte in the art may be additionally included. Examples of additionally added the solid ion conductor in the art are Li₂O—Al₂O₃—TiO₂—P₂O₅ (LATP), lithium superionic conductor (LISICON),

Li_{3.3}, PO₄₋ₓNₓ (LIPON, ₀<y<₃, and 0<x<4), Thio-LISICON (Li_{3.25}Ge_{0.25}P_{0.75}S₄), Li₂S, Li₂S—P₂S₅, Li₂S—SiS₂, Li₂S—GeS₂, Li₂S—B₂S₅, Li₂S—Al₂S₅, and the like, but are not limited thereto. Any compound available in the art may be used.

The solid electrolyte may be in the form of powder or molding product. The solid electrolyte in the form of molding product may include, for example, a pellet form, a sheet form, a thin film, or the like, but is not limited thereto. Various forms depending on the purpose of use may be used.

An electrochemical cell according to another embodiment may include: a positive electrode layer including a positive electrode active material layer; a negative electrode layer including a negative electrode active material layer; an electrolyte layer disposed between the positive electrode and the negative electrode; and the solid ion conductor.

In an embodiment, the positive electrode active material layer may include the solid ion conductor. Here, an average particle diameter D50 of the solid ion conductor in the positive electrode active material layer may be 2 μm or less or in a range of 0.5 μm to 2 μm or 1 μm to 2 The D₅₀ refers to a diameter of particles corresponding to 50 volume % in a cumulative particle size distribution. When the particle diameter D₅₀ of the solid ion conductor included in the positive electrode active material layer is 2 μm or less, the particles are densely packed, and thus the capacity characteristics thereof may be excellent during charging and discharging of the cell.

In an embodiment, the electrolyte layer may include the solid ion conductor. Here, an average particle diameter D₅₀ of the solid ion conductor in the electrolyte layer may be 5 μm or less, 2 μm or less, or in a range of 0.5 μm to 2 μm or 1 μm to 2 μm. When the average particle diameter D₅₀ of the solid ion conductor included in the electrolyte layer is within the ranges above, the density and uniformity of the electrolyte layer may be improved, and thus the occurrence of defects, such as pinholes or the like, in the electrolyte layer may be suppressed, and as a result, the lifespan characteristics of the cell may be improved.

In an embodiment, at least one selected from the positive electrode layer, the negative electrode layer, and the electrolyte layer may include the solid ion conductor. The solid ion conductor may be included in the positive electrode active material layer of the positive electrode layer or in the negative electrode active material layer of the negative electrode layer.

The amount of the solid ion conductor in the positive electrode layer may be, based on 100 parts by weight of the total weight of the positive electrode layer, in a range of 2 parts by weight to 70 parts by weight, for example 3 parts by weight to 70 parts by weight, for example 3 parts by weight to 60 parts by weight, and for example, 10 parts by weight to 60 parts by weight. When the amount of a sulfide-based solid electrolyte in the positive electrode layer is within the ranged above, the high-voltage stability of the electrochemical cell may be improved.

When the electrochemical cell according to an embodiment includes the solid ion conductor, the lithium-ion conductivity and chemical stability of the electrochemical cell may be improved.

The electrochemical cell may have a capacity retention rate of 88% or more, for example, 88% to 99.5%, at 100th cycle after charging and discharging at 4V or more in a thermostatic bath at 25° C.

First, a solid electrolyte layer is prepared.

The solid electrolyte layer may be prepared by mixing the aforementioned solid ion conductor with a binder and drying a resulting mixture, or by rolling powders of the solid ion conductor represented by Formula 1 in a constant shape at a pressure in a range of 1 ton to 10 tons. The aforementioned solid ion conductor may be used as a solid electrolyte.

Here, the average particle diameter of the solid electrolyte may be, for example, in a range of 0.5 μm to 20 μm. When the average particle diameter of the solid electrolyte is within the ranges above, the binding properties in the process of forming a sintered body may be improved, and thus the ionic conductivity and lifespan characteristics of the solid electrolyte particles may be improved.

Here, the thickness of the solid electrolyte layer thus prepared may be, for example, in a range of 10 μm to 200 μm. When the thickness of the solid electrolyte layer is within the ranges above, a sufficient movement rate of lithium ions may be ensured, and as a result, the high ionic conductivity may be obtained.

The solid electrolyte layer may further include, in addition to the aforementioned solid ion conductor, a solid electrolyte in the art, such as a sulfide-based solid electrolyte and/or an oxide-based solid electrolyte.

The sulfide-based solid electrolyte in the art may include, for example, lithium sulfide, silicon sulfide, phosphorus sulfide, boron sulfide, or a combination thereof. Particles of the sulfide-based solid electrolyte in the art may include Li₂S, P₂S₅, SiS₂, GeS₂, B₂S₃, or a combination thereof. The particles of the sulfide-based solid electrolyte in the art may include Li₂S or P₂S₅. The particles of the sulfide-based solid electrolyte in the art are known to have higher lithium-ion conductivity than other inorganic compounds. When a sulfide solid electrolyte material constituting the sulfide-based solid electrolyte in the art includes Li₂S—P₂S₅, a mixing molar ratio of Li₂S to P₂S₅ may be, for example, in a range of about 50:50 to about 90:10. In addition, as the sulfide-based solid electrolyte in the art, an inorganic solid electrolyte prepared by adding Li₂₊₂ₓZn₁₋ₓGeO₄ (“LISICON”), Li_{3+y}PO₄₋ₓNₓ (“LIPON”), L_{3.25}Ge_{0.25}P_{0.75}S₄ (“ThioLISICON”), Li₂O—Al₂O₃—TiO₂—P₂O₅ (“LATP”), or the like to an inorganic solid electrolyte, such as Li₂S—P₂S₅, SiS₂, GeS₂, B₂S₃, or a combination thereof. Non-limiting examples of the sulfide solid electrolyte material may be: Li₂S—P₂S₅; Li₂S—P₂S₅—LiX (where X is a halogen element); Li₂S—P₂S₅—Li₂O; Li₂S—P₂S₅—Li₂O—LiI; Li₂S—SiS₂; Li₂S—SiS₂—LiI; Li₂S—SiS₂—LiBr; Li₂S—SiS₂—LiCl; Li₂S—SiS₂—B₂S₃—LiI; Li₂S—SiS₂—P₂S₅—LiI; Li₂S—B₂S₃; Li₂S—P₂S₅—ZₘSₙ (where m and n each indicate a positive number, and Z is Ge, Zn, or Ga); Li₂S—GeS₂; Li₂S—SiS₂—Li₃PO₄; and Li₂S—SiS₂—LiₚMO_{q} (where p and q each indicate a positive number, and M is P, Si, Ge, B, Al, Ga, or In). In this regard, the sulfide-based solid electrolyte material in the art may be prepared by treating raw starting materials of the sulfide-based solid electrolyte material (e.g., Li₂S, P₂S₅, etc.) by a melt quenching method, a mechanical milling method, and the like. Also, a calcination process may be performed after the treatment.

The binder included in the solid electrolyte layer may include, for example, styrene butadiene rubber (SBR), polytetrafluoroethylene, polyvinylidene fluoride, polyethylene, polyvinyl alcohol, or the like, but is not limited thereto. Any material available as a binder in the art may be used. The binder included in the solid electrolyte layer may be the same as or different from a binder included in a positive electrode layer and a negative electrode layer.

Next, a positive electrode layer is prepared.

A positive electrode active material layer including a positive electrode active material may be formed on a current collector to prepare the positive electrode layer. Here, the average particle diameter of the positive electrode active material may be, for example, in a range of 2 μm to 10 μm.

As the positive electrode active material, any material generally available for a secondary battery in the art may be used without limitation. For example, lithium transition metal oxide, transition metal sulfide, or the like may be used. For example, at least one composite oxide including lithium and a metal selected from cobalt, manganese, nickel, and a combination thereof may be used, and a specific example thereof may be a compound represented by one of the following formulae: LiₐA_{1-b}B¹_{b}D¹₂ (where 0.90≤a≤1.8 and 0≤b≤0.5); LiₐE_{1-b}B¹bO_{2-c}D¹_{c} (where 0.90≤a≤1.8, 0≤b≤0.5, and 0≤c≤0.05); LiE_{2-b}B¹_{b}O_{4-c}D¹_{c} (where 0≤b≤0.5 and 0≤c≤0.05); LiₐNi_{1-b-c}Co_{b}B¹_{c}D¹_{α}(where 0.90≤a≤1.8, 0≤b≤0.5, 0≤c≤0.05, and 0<α≤2); LiₐNi_{1-b-c}Co_{b}B¹_{c}O_{2-α}F¹_{α} (where 0.90≤a≤1.8, 0≤b≤0.5, 0≤c≤0.05, and 0<α≤2); LiₐNi_{1-b-c}Co_{b}B¹_{c}O_{-α}F¹_{α}(where 0.90≤a≤1.8, 0≤b≤0.5, 0≤c≤0.05, and 0<α<2); LiₐNi_{1-b-c}Mn_{b}B¹_{c}D¹_{α}(where 0.90≤a≤1.8, 0≤b≤0.5, 0≤c≤0.05, and 0<α≤2); LiₐNi_{1-b-c}Mn_{b}B¹_{c}O_{2-α}F¹_{α}(where 0.90≤a≤1.8, 0≤b≤0.5, 0≤c≤0.05, and 0<α<2); LiₐNi_{1-b-c}Mn_{b}B¹_{c}O_{2-α}F¹₂ (where 0.90≤a≤1.8, 0≤b≤0.5, 0≤c≤0.05, and 0<α<2); LiₐNi_{b}E_{c}G_{d}O₂ (where 0.90≤a≤1.8, 0≤b≤0.9, 0≤c≤0.5, and 0.001≤d≤0.1); LiₐNi_{b}Co_{c}Mn_{d}GeO₂ (where 0.90≤a≤1.8, 0≤b≤0.9, 0≤c≤0.5, 0≤d≤0.5, and 0.001≤e≤0.1); LiₐNiG_{b}O₂ (where 0.90≤a≤1.8 and 0.001≤b≤0.1); LiaCoG_{b}O₂ (where 0.90≤a≤1.8 and 0.001≤b≤0.1); LiₐMnG_{b}O₂ (where 0.90≤a≤1.8 and 0.001≤b≤0.1); LiₐMn₂G_{b}O₄ (where 0.90≤a≤1.8 and 0.001≤b≤0.1); QO₂; QS₂; LiQS₂; V₂O₅; LiV₂O₂; LiIO₂; LiNiVO₄; Li₍₃₋₅₎J₂(PO₄)₃ (were 0≤f≤2); Li_{(3-f)}Fe₂(PO₄)₃ (0≤f≤2); and LiFePO₄. In the formulae above, A may be Ni, Co, Mn, or a combination thereof; Bi may be Al, Ni, Co, Mn, Cr, Fe, Mg, Sr, V, a rare earth element, or a combination thereof; D¹ may be O, F, S, P, or a combination thereof; E may be Co, Mn, or a combination thereof; F¹ may be F, S, P, or a combination thereof; G may be Al, Cr, Mn, Fe, Mg, La, Ce, Sr, V, or a combination thereof; Q may be Ti, Mo, Mn, or a combination thereof; I may be Cr, V, Fe, Sc, Y, or a combination thereof; and J may be V, Cr, Mn, Co, Ni, Cu, or a combination thereof. For example, the positive electrode active material may be LiCoO₂, LiMnₓO₂ₓ (where x=1 and 2), LiNi₁₋ₓMnₓO₂ₓ (where 0≤x≤1), Ni_{1-x-y}CoₓMn_{y}O₂ (where 0≤x≤0.5 and 0≤y≤0.5), Ni_{1-x-y}CoₓAl_{y}O₂ (where 0≤x≤0.5 and 0≤y≤0.5), LiFePO₄, TiS₂, FeS₂, TiS₃, FeS₃, or the like.

A compound having a coating layer may be also added to the surface of the aforementioned compound, and a mixture of the aforementioned compound and a compound having a coating layer may be also used. Such a coating layer added to the surface of the aforementioned compound may include, for example, a coating element compound such as an oxide of a coating element, hydroxide of a coating element, oxyhydroxide of a coating element, oxycarbonate of a coating element, or hydroxy carbonate of a coating element. The compound constituting the coating layer may be amorphous or crystalline. The coating element included in the coating layer may be Mg, Al, Co, K, Na, Ca, Si, Ti, V, Sn, Ge, Ga, B, As, Zr, or a mixture thereof. A method of forming the coating layer may be selected within a range that does not adversely affect the physical properties of the positive electrode active material. The coating method may be, for example, spray coating, dipping method, or the like. A detailed description of the coating method will be omitted because it may be well understood by those in the art.

The positive electrode active material may include, for example, a lithium salt of a transition metal oxide having a layered rock salt type structure, among the lithium transition metal oxides described above. The term “layered rock salt type structure” as used herein may refer to, for example, a structure in which oxygen atomic layers and metal layers are alternately arranged regularly in the <111> direction of a cubic rock salt type structure to form a two-dimensional plane by each of the atomic layers. The term “cubic rock salt type structure” as used herein refers to a NaCl type structure which is one type of crystal structures, and in detail, may refer to a structure in which a face centered cubic lattice (fcc) formed by respective anions and cations is misaligned from each other by ½ of the ridge of a unit lattice. The lithium transition metal oxide having the layered rock salt type structure may be a ternary lithium transition metal oxide, for example, LiNiₓCo_{y}Al_{z}O₂ (NCA) or LiNiₓCo_{y}Mn_{z}O₂ (NCM) (where 0<x<1, 0<y<1, 0<z<1, and x+y+z=1). When the positive electrode active material includes a ternary lithium transition metal oxide having the layered rock salt type, the all-solid-state secondary battery 1 may have further improved energy density and thermal stability.

The positive electrode active material may be covered by the coating layer as described above. For use as the coating layer, any coating layer known for a positive electrode active material of an all-solid secondary battery may be used. The coating layer may include, for example, Li₂O—ZrO₂ (LZO) and the like.

When the positive electrode active material includes, for example, Ni as the ternary lithium transition metal oxide such as NCA or NCM, the volume density of the all- solid battery increases so that the metal elution of the positive electrode active material may be reduced in a charged state. Consequently, the cycle characteristics of the all-solid battery may be improved.

The positive electrode active material may be in the form of a particle shape, such as a spherical sphere, an elliptical sphere, and the like. A particle diameter of the positive electrode active material is not particularly limited, but may be within a range applicable to the positive electrode active material of the all-solid battery 1. The amount of the positive electrode active material in the positive electrode layer is not particularly limited, and is within a range applicable to a positive electrode layer of an all-solid battery in the art. The amount of the positive electrode active material in the positive electrode active material layer may be, for example, in a range of 50 wt % to 95 wt %.

The positive electrode layer may include the positive electrode active material, and the positive electrode active material may be at least one selected from a lithium transition metal oxide, a lithium transition metal oxide having a layered crystal structure, a lithium transition metal oxide having an olivine crystal structure, and a lithium transition metal oxide having a spinel crystal structure.

The positive electrode active material layer may include the aforementioned solid ion conductor. For example, the positive electrode active material layer and the solid electrolyte layer may simultaneously include the aforementioned solid ion conductor.

The positive electrode active material layer may include a binder. The binder may include, for example, SBR, polytetrafluoroethylene, polyvinylidene fluoride, polyethylene, and the like.

The positive electrode active material layer may include a conductive material.

The conductive material may include, for example, graphite, carbon black (CB), acetylene black (AB), ketj en black (KB), carbon fiber, metal powder, or the like.

The positive electrode active material layer may further include, for example, an additive such as a filler, a coating agent, a dispersant, an ion conductive auxiliary agent, and the like, in addition to the positive electrode active material, the solid electrolyte, the binder, and the positive electrode active material.

For use as the filler, the coating agent, the dispersant, the ion conductive auxiliary agent, and the like that may be included in the positive electrode active material layer, a known material generally used for an electrode of an all-solid battery may be used.

As the positive electrode current collector, for example, a plate or a foil, consisting of aluminum (Al), indium (In), copper (Cu), magnesium (Mg), stainless steel, titanium (Ti), iron (Fe), cobalt (Co), nickel (Ni), zinc (Zn), germanium (Ge), lithium (Li), or an alloy thereof, may be used. The positive electrode current collector may be omitted.

The positive electrode current collector may further include a carbon layer disposed on one surface or both surfaces of the metal substrate. When the carbon layer is additionally disposed on the metal substrate, a metal of the metal substrate may be prevented from being corroded by a solid electrolyte included in a positive electrode layer, and the interfacial resistance between the positive electrode active material layer and the positive electrode current collector may be reduced. The thickness of the carbon layer may be, for example, in a range of 1 μm to 5 μm. When the carbon layer is too thin, the contact between the metal substrate and the solid electrolyte may not be completely blocked. When the carbon layer is too thick, the energy density of the all-solid battery may be reduced. The carbon layer may include amorphous carbon, crystalline carbon, or the like.

Next, a negative electrode layer is prepared.

The negative electrode layer may be prepared in the same manner as in the positive electrode layer, except that a negative electrode active material is used instead of the positive electrode active material. A negative electrode active material layer including a negative electrode active material may be formed on a negative electrode current collector to prepare a negative electrode layer.

The negative electrode active material layer may further include the aforementioned solid ion conductor.

The negative electrode active material may include a lithium metal, a lithium metal alloy, or a combination thereof.

The negative electrode active material layer may further include, in addition to the lithium metal, the lithium metal alloy, or a combination thereof, a negative electrode active material in the art. The negative electrode active material in the art may include, for example, at least one selected from the group consisting of a metal alloyable with lithium, a transition metal oxide, a non-transition metal oxide, and a carbon-based material. Examples of the metal alloyable with lithium include silver (Ag), silicon (Si), tin (Sn), aluminum (Al), germanium (Ge), lead (Pb), bismuth (Bi), antimony (Sb), a Si—Y alloy (where Y is an alkali metal, an alkaline earth metal, a Group 13 element, a Group 14 element, a transition metal, a rare earth element, or a combination thereof, and Y is not Si), a Sn—Y alloy (where Y is an alkali metal, an alkaline earth-metal, a Group 13 element, a Group 14 element, a transition metal, a rare earth element, or a combination thereof, and Y is not Sn), and the like. The element Y may be, for example, Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or a combination thereof. The transition metal oxide may include, for example, a lithium titanium oxide, a vanadium oxide, a lithium vanadium oxide, and the like. The non-transition metal oxide may include, for example, SnO₂, SiOx (where 0<x<2), and the like. The carbon-based material may include, for example, crystalline carbon, amorphous carbon, or a mixture thereof. The crystalline carbon may be non-shaped, sheet, flake, spherical, or fiber-shaped natural graphite or artificial graphite. The amorphous carbon may include soft carbon (low-temperature calcined carbon), hard carbon (hard carbon), mesophase pitch carbide, calcined coke, and the like.

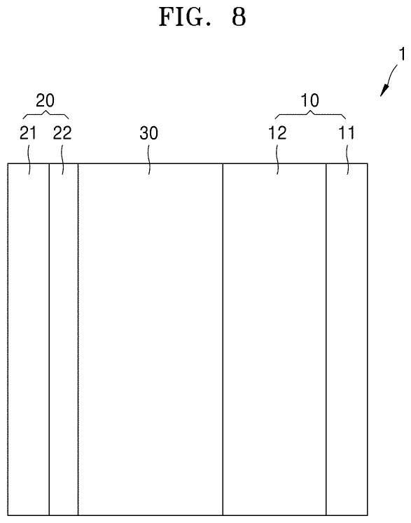

Referring to FIG. 8, an all-solid battery 40 according to an embodiment includes a solid electrolyte layer 30 a positive electrode layer 10 disposed on one surface of the solid electrolyte layer 30, and a negative electrode layer 20 disposed on the other surface of the solid electrolyte layer 30. The positive electrode layer 30 includes a positive electrode active material layer 12 in contact with the solid electrolyte layer 30 and a positive electrode current collector 11 in contact with the positive electrode active material layer 12, and the negative electrode layer 20 includes a negative electrode active material layer 22 in contact with the solid electrolyte layer 30 and a negative electrode current collector 11 in contact with the negative electrode active material layer 22. In an embodiment, the formation of the all-solid battery 40 may be completed in a way that, for example, the positive electrode active material layer 12 and the negative electrode active material layer 22 are respectively formed on both surfaces of the solid electrolyte layer 30, and then the positive electrode current collector 11 and the negative electrode current collector 21 are respectively formed the positive electrode active material layer 12 and the negative electrode active material layer 22. In one or more embodiments, the formation of the all-solid battery 40 may be completed in a way that, for example, on the negative electrode current collector 21, the negative electrode active material layer 22, the solid electrolyte layer 30, the positive electrode active material layer 12, and the positive electrode current collector 11 are sequentially stacked in the stated order.

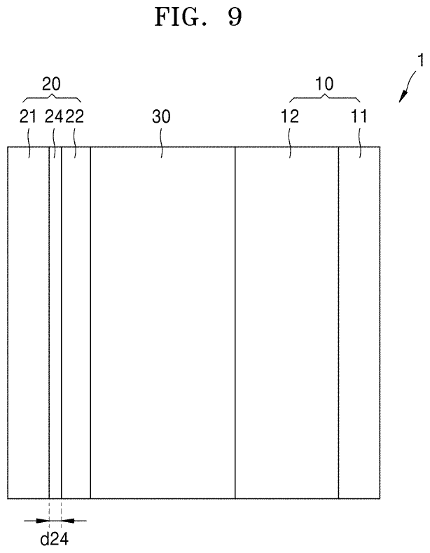

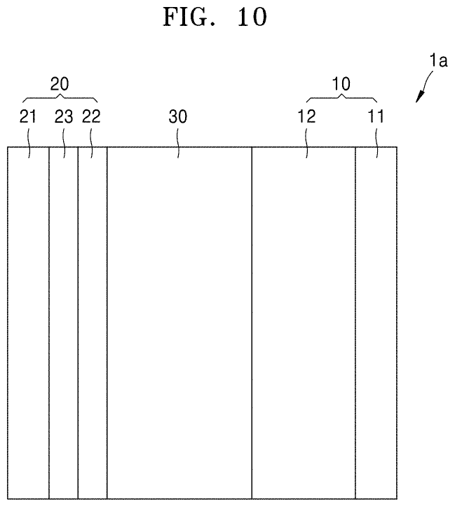

Referring to FIGS. 9 and 10, the all-solid battery 1 includes: for example, the positive electrode layer 10 including the positive electrode active material layer 12 disposed on the positive electrode current collector 11; the negative electrode layer 20 including the negative electrode active material layer 22 disposed on the negative electrode current collector 21; and the electrolyte layer 30 disposed between the positive electrode layer 10 and the negative electrode layer 20, wherein the positive electrode active material layer 12 and/or the electrolyte layer 30 includes the aforementioned solid ion conductor.

An all-solid battery according to another embodiment may be prepared as follows.

A positive electrode layer and a solid electrolyte layer are respectively prepared in the same manner as in those included the aforementioned all-solid battery.

Next, a negative electrode layer is prepared.

Referring to FIGS. 8 to 10, the negative electrode layer 20 includes the negative electrode current collector 21 and the negative electrode active material layer 22 disposed on the negative electrode current collector 21, and the negative electrode active material layer 22 may include, for example, a negative electrode active material and a binder.

The negative electrode active material included in the negative electrode active material layer 22 may have, for example, a particle shape. The average particle diameter of the negative electrode active material having a particle shape may be, for example, 4 1 μm or less, 4 3 μm or less, 2 μm or less, 1 μm or less, or 900 nm or less. For example, the average particle diameter of the negative electrode active material having a particle shape may be, for example, in a range of 10 nm to 4 μm, 10 nm to 3 μm, 10 nm to 2 μm, 10 nm to 1 μm or 10 nm to 900 nm. When the average particle diameter of the negative electrode active material is within the ranges above, lithium may be more easily subjected to reversible absorbing and/or desorbing during charging and discharging. The average particle diameter of the negative electrode active material may be, for example, a median diameter D50 measured by using a laser particle size distribution meter.

The negative electrode active material included in the negative electrode active material layer 22 may include, for example, at least one selected from a carbon-based negative electrode active material and a metallic or metalloid negative electrode active material.

The carbon-based negative electrode active material may be, in particular, amorphous carbon. The amorphous carbon may include, for example carbon black (CB), acetylene black (AB), furnace black (FB), ketj en black (KB), graphene, or the like, but is not necessarily limited thereto. Any material categorized as amorphous carbon in the art may be used. The amorphous carbon is carbon that has no or very low crystallinity, and in this regard, may be distinguished from crystalline carbon or graphite-based carbon.

The metallic or metalloid negative electrode active material may include at least one selected from gold (Au), platinum (Pt), palladium (Pd), silicon (Si), silver (Ag), aluminum (Al), bismuth (Bi), tin (Sn), and zinc (Zn), but is not necessarily limited thereto. Any material available as a metallic negative electrode active material or metalloid negative electrode active material capable of forming an alloy or compound with lithium in the art may be used. For example, since nickel (Ni) does not form an alloy with lithium, Ni is not a metallic negative electrode active material.

The negative electrode active material layer 22 may include one type of the negative electrode active material from among the negative electrode active materials described above, or a mixture of multiple negative electrode active materials that are different from each other. In an embodiment, the negative electrode active material layer 22 may include only amorphous carbon, or may include at least one selected from Au, Pt, Pd, Si, Ag, Al, Bi, Sn, and Zn. In one or more embodiments, the negative electrode active material layer 22 may include a mixture of amorphous carbon with at least one selected from Au, Pt, Pd, Si, Ag, Al, Bi, Sn, and Zn. A mixing ratio of the amorphous carbon to metal or the like in the mixture may be, for example, as a weight ratio, in a range of about 10:1 to about 1:2, about 5:1 to about 1:1, or about 4:1 to about 2:1, but is not necessarily limited thereto. The mixing ratio may be chosen according to the characteristics of the all- solid-state secondary battery 1. When the negative electrode active material has such a composition, cycle characteristics of the all-solid-state secondary battery 1 may be further improved.

The negative electrode active material included in the first negative electrode active material layer 22 may include, for example, a mixture of a first particle consisting of amorphous carbon and a second particle consisting of a metal or metalloid. The metal or metalloid may include, for example, Au, Pt, Pd, Si, Ag, Al, Bi, Sn, Zn, and the like. The metalloid may be, in other words, a semiconductor. The amount of the second particle may be in a range of 8 wt % to 60 wt %, 10 wt % to 50 wt %, 15 wt % to 40 wt %, or 20 wt % to 30 wt %, based on the total weight of the mixture. When the amount of the second particle is within the ranges above, for example, the cycle characteristics of the all-solid-state secondary battery 1 may be further improved.

The binder included in the negative electrode active material layer 22 may include, for example, SBR, polytetrafluoroethylene, polyvinylidene fluoride, polyethylene, vinylidene fluoride/hexafluoropropylene copolymer, polyacrylonitrile, polymethyl methacrylate, or the like, but is not necessarily limited thereto. Any material available as a binder in the art may be used. The binder may be used alone, or may be used with multiple binders that are different from each other.

When the negative electrode active material layer 22 includes the binder, the negative electrode active material layer 22 may be stabilized on the negative electrode current collector 21. In addition, despite a change in volume and/or relative position of the negative electrode active material layer 22 during charging and discharging, cracking of the negative electrode active material layer 22 may be suppressed. For example, when the negative electrode active material layer 22 does not include the binder, the negative electrode active material layer 22 may be easily separated from the negative electrode current collector 21. At a portion where the negative electrode current collector 21 is exposed by the separation of the negative electrode active material layer 22 from the negative electrode current collector 22, the possibility of occurrence of a short circuit may increase as the negative electrode current collector 21 is in contact with the electrolyte layer 30. The negative electrode active material layer 22 may be prepared by, for example, coating the negative electrode current collector 21 with a slurry in which a material constituting the negative electrode active material layer 22 is dispersed, and then drying the coated negative electrode current collector 21. When the negative electrode active material layer 22 includes the binder, the negative electrode active material may be stably dispersed in the slurry. For example, when the negative electrode current collector 21 is coated with the slurry by a screen printing method, clogging of the screen (for example, clogging by an agglomerate of the negative electrode active material) may be suppressed.

The negative electrode active material layer 22 may further include additives, for example, a filler, a coating agent, a dispersant, an ionic conductive auxiliary agent, or the like, as used in the conventional all-solid-state secondary battery 1.

A thickness of the negative electrode active material layer 22 may be, for example, less than or equal to about 50%, less than or equal to about 40%, less than or equal to about 30%, less than or equal to about 20%, less than or equal to about 10%, or less than or equal to about 5%, of the thickness of the positive electrode active material layer 12. The thickness of the negative electrode active material layer 22 may be, for example, in a range of about 1 μm to about 20 μm, about 2 μm to about 10 μm, or about 3 μm to about 7 μm. When the negative electrode active material layer 22 is too thin, lithium dendrites formed between the negative electrode active material layer 22 and the negative electrode current collector 21 may collapse the negative electrode active material layer 22, and thus the cycle characteristics of the all-solid battery 1 may be difficult to improve. When the negative electrode active material layer 22 is too thick, the energy density of the all-solid battery 1 may be lowered and the internal resistance of the all-solid battery 1 by the negative electrode active material layer 22 may increase, and thus the cycle characteristics of the all-solid battery 1 may be difficult to improve.

When the thickness of the negative electrode active material layer 22 is reduced, for example, charging capacity of the negative electrode active material layer 22 may be also reduced. The charging capacity of the negative electrode active material layer 22 may be, for example, less than or equal to about 50%, less than or equal to about 40%, less than or equal to about 30%, less than or equal to about 20% or, less than or equal to about 10%, or less than or equal to about 5%, with respect to the charging capacity of the positive electrode active material layer 12. The charging capacity of the negative electrode active material layer 22 may be, for example, in a range of about 0.1% to about 50%, about 0.1% to about 40%, about 0.1% to about 30%, about 0.1% to about 20%, about 0.1% to about 10%, about 0.1% to about 5%, or about 0.1% to about 2%, with respect to the charging capacity of the positive electrode active material layer 12. When the charging capacity of the negative electrode active material layer 22 is significantly small, the negative electrode active material layer 22 becomes very thin. In this regard, lithium dendrites formed between the negative electrode active material layer 22 and the negative electrode current collector 21 during a repeated process of charging and discharging may collapse the negative electrode active material layer 22, and thus the cycle characteristics of the all-solid battery 1 may be difficult to improve. When the charging capacity of the negative electrode active material layer 22 is excessively increased, the energy density of the all-solid battery 1 may be lowered and the internal resistance of the all-solid battery 1 by the negative electrode active material layer 22 may increase, and thus the cycle characteristics of the all-solid battery 1 may be difficult to improve.

The charging capacity of the positive electrode active material layer 12 may be obtained by multiplying the charging capacity density (mAh/g) of the positive electrode active material by the mass of the positive electrode active material in the positive electrode active material layer 12. When several types of the positive electrode active material are used, for each positive electrode active material, the charging capacity density is multiplied by the mass, and the sum of these values is the charging capacity of the positive electrode active material layer 12. The charging capacity of the negative electrode active material layer 22 may be calculated in the same way. That is, the charging capacity of the negative electrode material layer 22 may be obtained by multiplying the charging capacity density (mAh/g) of the negative electrode active material 22 by the mass of the negative electrode active material in negative electrode active material layer 22. When several types of the negative electrode active material are used, for each negative electrode active material, the charging capacity density is multiplied by the mass, and the sum of these values is the charging capacity of the negative electrode active material layer 22. Here, the charge capacity densities of the positive electrode active material and the negative electrode active material are capacities estimated by using an all-solid half-cell using lithium metal as a counter electrode. The charging capacities of the positive electrode active material layer 12 and the negative electrode active material layer 22 may be directly measured by measuring the charging capacity obtained by using the all-solid half-cell. When the measured charge capacity is divided by the mass of each active material, the charge capacity density is obtained. In an embodiment, the charging capacities of the positive electrode active material layer 12 and the negative electrode active material layer 22 may be initial charging capacities measured during the first cycle of charging.

Referring to FIG. 9, an all-solid battery 1a may further include, for example, a metal layer 23 disposed between the negative electrode current collector 21 and the negative electrode active material layer 22. The metal layer 12 may include Li or a Li alloy. Thus, the metal layer 23 may act as, for example, a Li reservoir. The Li alloy may include, for example, a Li—Al alloy, a Li—Sn alloy, a Li—In alloy, a Li—Ag alloy, a Li—Au alloy, a Li—Zn alloy, a Li—Ge alloy, a Li—Si alloy, or the like, but is not limited thereto. Any material alloyable with Li in the art may be used. The metal layer 23 may consist of one of these alloys or lithium, or may consist of several types of alloy.

The thickness of the metal layer 23 is not particularly limited, but may be, for example, in a range of 1 μm to 1,000 μm, 1 μm to 500 μm, 1 μm to 200 μm, 1 μm to 150 μm, 1 μm to 100 μm, or 1 μm to 50 μm. When the metal layer 23 is too thin, the metal layer 23 may have a difficulty in performing a function as a Li reservoir. When the metal layer 23 is too thick, the mass and volume of the all-solid battery 1a may be increased, and thus the cycle characteristics of the all-solid battery 1a may be rather degraded. The metal layer 23 may be, for example, a metal foil having a thickness within the ranges above.

In the all-solid battery 1a, the metal layer 23 may be, for example, disposed between the negative electrode current collector 21 and the negative electrode active material layer 22 before assembly of the all-solid battery 1a, or may be precipitated between the negative electrode current collector 21 and the negative electrode active material layer 22 by charging after assembly of the all-solid battery 1a. When the metal layer 23 is disposed between the negative electrode current collector 21 and the negative electrode active material layer 22 before assembly of the all-solid battery 1a, the metal layer 23, which includes Li, may serve as a Li reservoir. For example, a Li foil may be disposed between the negative electrode current collector 21 and the negative electrode active material layer 22 before assembly of the all-solid battery 1a. Accordingly, the cycle characteristics of the all-solid battery 1a including the metal layer 23 may be further improved. When the metal layer 23 is precipitated by charging after assembly of the all-solid battery 1a, the energy density of the all-solid battery 1a, which does not include the metal layer 23 at the time of assembly of the all-solid battery 1a, may increase. For example, during charging of the all-solid battery 1, the all-solid battery 1 may be charged in excess of the charging capacity of the negative electrode active material layer 22. That is, the negative electrode active material layer 22 may be overcharged. At the beginning of charging, Li may be adsorbed onto the negative electrode active material layer 22. The negative electrode active material included in the negative electrode active material layer 22 may form then form an alloy or compound with Li ions that have transported from the positive electrode layer 10. When the charging is performed in excess of the capacity of the negative electrode active material layer 22, for example, Li may be precipitated on a rear surface of the negative electrode active material layer 22, i.e., a surface between the negative electrode current collector 21 and the negative electrode active material layer 22, and due to the precipitated Li, a metal layer corresponding to the metal layer 23 may be formed. The metal layer 23 may be a metal layer mainly composed of lithium (i.e., lithium metal). Such a result may be obtained, for example, when the negative electrode active material included in the negative electrode active material layer 22 consists of a material that forms an alloy or compound with Li. During discharging, Li included in the negative electrode active material layer 22 and the metal layer 23 may be ionized and migrate toward the positive electrode layer 10. In this regard, Li may be used as the negative electrode active material in the all-solid battery 1. In addition, since the negative electrode active material layer 22 coats the metal layer 23, the negative electrode active material layer 22 may serve as a protective layer for the metal layer 23, and at the same time, may serve to suppress the precipitation growth of lithium dendrites. Therefore, the short circuit and the capacity degradation of the all-solid battery 1 may be suppressed, and consequently, the cycle characteristics of the all-solid battery 1 may be improved. In addition, when the metal layer 23 is disposed by charging after assembly of the all-solid battery 1, the negative electrode current collector 21, the negative electrode active material layer 22, and a region therebetween may be, for example, Li-free regions that do not include Li in an initial state or a post-discharge state of the all-solid battery 1.

The negative electrode current collector 21 may be formed of, for example, a material that does not react with Li, that is, a material that forms neither an alloy nor a compound with Li. A material for forming the negative electrode current collector 21 may be, for example, copper (Cu), stainless steel, titanium (Ti), iron (Fe), cobalt (Co), nickel (Ni), and the like, but is not limited thereto. Any material available as an electrode current collector in the art may be used. The negative electrode current collector 21 may be formed of one of the above-described metals, an alloy of two or more of the above described metals, or a coating material. The negative electrode current collector 21 may be, for example, in the form of a plate or foil.

The all-solid battery 1 may further include, for example, a thin film, which includes an element capable of forming an alloy with Li, on the negative electrode current collector 21. The thin film may be disposed between the negative electrode current collector 21 and the negative electrode active material layer 22. The thin film may include, for example, an element capable of forming an alloy with Li. The element capable of forming an alloy with lithium may include, for example, gold, silver, zinc, tin, indium, silicon, aluminum, bismuth, and the like, but is not necessarily limited thereto. Any material available as an element capable of forming an alloy with lithium in the art may be used. The thin film may be formed of one of these metals or an alloy of several types of metals. By disposing the thin-film 24 on the negative electrode current collector 21, for example, a precipitation shape of the metal layer 23 precipitated between the thin film 24 and the negative electrode active material layer 22 may be further flattened, and accordingly, the cycle characteristics of the all-solid battery 1 may be further improved.

The thickness of the thin film may be, for example, in a range of 1 nm to 800 nm, 10 nm to 700 nm, 50 nm to 600 nm, or 100 nm to 500 nm. When the thickness of the thin film is less than 1 nm, the thin film may have a difficulty in exhibiting a function thereof. When the thin film is too thick, the thin film 24 itself may adsorb Li so that an amount of Li precipitated in the negative electrode may be decreased, and accordingly, the energy density and the cycle characteristics of the all-solid battery 1 may be degraded. The thin film may be disposed on the negative electrode current collector 21, 21a, or 21b by, for example, a vacuum deposition method, a sputtering method, a electrodeposition method, or the like, but is not necessarily limited thereto, Any method capable of forming a thin film in the art may be used.

A method of preparing the solid ion conductor according to another aspect includes: providing a mixture by bringing a lithium precursor, a metal (M) precursor, a phosphorus (P) precursor, and a halogen precursor into contact with each other; and providing a solid ion conductor by performing heat treatment on the mixture in an inert atmosphere, to thereby prepare the solid ion conductor.

The lithium precursor may include, for example, Li₂S, Li₂O, or a combination thereof. Here, Li₂O may be used as an oxygen precursor for forming the solid ion conductor.

The metal precursor may be an M-containing oxide or sulfide, and examples thereof may include zinc oxide, zinc sulfide (ZnS), zinc chloride, mercury oxide, cadmium oxide, mercury chloride, cadmium chloride, mercury sulfide, cadmium sulfide, or a combination thereof.

As the phosphorus precursor, for example, P₂S₅, red phosphorus, white phosphorus, phosphorus powder, P₂O₅, (NH₄)₂HPO₄, (NH₄)H₂PO₄, Na₂HPO₄, Na₃PO₄, and the like may be used.

The halogen precursor may be, for example, lithium halide. The lithium halide may be, for example, LiCl, LiI, LiBr, or a combination thereof

A precursor mixture may be formed by contacting the lithium precursor, the metal precursor, the phosphorus precursor, and the halogen precursor in a stoichiometric amount to obtain a desired solid ion conductor, and then heat treatment is performed thereon. The contacting may include, for example, milling including ball milling, or pulverization.

The precursor mixture mixed in a stoichiometric amount may be heat-treated in an inert atmosphere to prepare a solid ion conductor.

The heat treatment may be performed at a temperature, for example, in a range of 400° C. to 700° C., 400° C. to 650° C., 400° C. to 600° C., 400° C. to 550° C., or 400° C. to 500° C. The heat treatment may be performed for, for example, 1 hour to 36 hours, 2 hours to 30 hours, 4 hours to 24 hours, 10 hours to 24 hours, or 12 hours to 24 hours. The inert atmosphere is an atmosphere containing inert gas. The inert gas may include, for example, nitrogen, argon, or the like, but is not necessarily limited thereto. Any inert gas used in the art may be used.

The solid ion conductor according to an embodiment may be used in a storage battery, a supercapacitor, a fuel battery, a sensor, a thermoelectric converter, a window, or an electrochromic device such as VDU and exterior wall.

The present disclosure will be described in more detail through Examples and Comparative Examples below, but is not meant to be limited to the following examples.

(Preparation of Solid Ion Conductor)

### Example 1

In a glove box under an Ar atmosphere, Li₂S as a lithium (Li) precursor, P₂S₅ as a phosphorus (P) precursor, ZnO as a zinc (Zn) precursor, and LiCl and LiBr halogen precursors were mixed at a stoichiometric ratio to obtain a desired composition, Li_{5.36}Zn_{0.02}PS_{4.38}O_{0.02}Cl_{1.4}Br_{0.2}. Then, in a planetary ball mill including zirconia (YSZ) balls in an Ar atmosphere, the precursors were pulverized and mixed at 100 rpm for 1 hour, and then, pulverized and mixed again at 800 rpm for 30 minutes to obtain a precursor mixture. The precursor mixture thus obtained was placed in a carbon crucible, and the carbon crucible was vacuum-sealed by using a quartz glass tube. The vacuum-sealed pellet was heated by using an electric furnace in an Ar atmosphere by raising the temperature from room temperature (25° C.) up to 500° C. at a rate of 1.0° C./minute. Then, heat treatment was performed thereon at 500° C. for 12 hours, followed by cooling to room temperature at a rate of 1.0° C./minute, so as to prepare a solid ion conductor.

### Examples 2 and 3

A solid ion conductor was prepared in the same manner as in Example 1, except that the amounts of a Li precursor, Li₂S, a P precursor, P₂S₅, a Zn precursor, ZnO, and halogen precursors, LiCl and LiBr, were stoichiometrically controlled to obtain a solid ion conductor having a composition of Table 1.

### Example 4

A solid ion conductor was prepared in the same manner as in Example 1, except that zinc chloride (ZnCl₂) was used as the Zn precursor, ZnO, and lithium oxide (Li₂O) was used as an oxygen precursor to obtain a solid ion conductor having a composition of Table 1.

### Examples 5 and 6

A solid ion conductor was prepared in the same manner as in Example 1, except that, in the preparation of a mixture, CdO was used as a cadmium precursor instead of the zinc precursor, ZnO, and mercury oxide was used as a mercury precursor to obtain a solid ion conductor having a composition of Table 1.

### Example 7

A solid ion conductor was prepared in the same manner as in Example 1, except that zinc sulfide (ZnS) was used as the Zn precursor, ZnO, and lithium oxide (Li₂O) was used as oxygen precursor to obtain a solid ion conductor having a composition of Table 1.

### Comparative Example 1

In a glove box under an Ar atmosphere, a Li precursor, Li₂S, a P precursor, P₂S₅, a Zn precursor, ZnO, and halogen precursors, LiCl and LiBr, were mixed at a stoichiometric ratio to obtain a mixture having a desired composition of Li₆PS₅Cl. Then, in a planetary ball mill including zirconia (YSZ) balls in an Ar atmosphere, the mixture was pulverized and mixed at 100 rpm for 1 hour, and then, pulverized and mixed again at 800 rpm for 30 minutes to obtain a precursor mixture. The precursor mixture thus obtained was placed in a carbon crucible, and the carbon crucible was vacuum-sealed by using a quartz glass tube. The vacuum-sealed pellet was heated by using an electric furnace by raising the temperature from room temperature up to 500° C. at a rate of 1.0° C./minute. Then, heat treatment was performed thereon at 500° C. for 12 hours, followed by cooling to room temperature at a rate of 1.0° C./minute, so as to prepare a solid ion conductor.

### Comparative Example 2

In a glove box under an Ar atmosphere, a solid ion conductor was prepared in the same manner as in Example 1, except that the amounts of a Li precursor, Li₂S, a P precursor, P₂S₅, and a Cl precursor, LiCl, were stoichiometrically controlled to obtain a desired composition of Li_{5.96}Zn_{0.02}PS₅Cl.

### Comparative Example 3

A solid ion conductor was prepared in the same manner as in Example 1, except that, in the preparation of the mixture, the Zn precursor, ZnO, was not added to obtain a solid ion conductor having a desired composition of Table 1.

### Comparative Example 4

A solid ion conductor was prepared in the same manner as in Example 1, except that the amounts of precursors were changed stoichiometrically to obtain a solid ion conductor having a composition of Table 1.

### Comparative Example 5

A solid ion conductor was prepared in the same manner as in Example 1, except that, in the preparation of the mixture, the brome (Br) precursor, LiBr, was not used to obtain a solid ion conductor having a desired composition of Table 1.

### Comparative Examples 6 and 7

A solid ion conductor was prepared in the same manner as in Example 1, except that CaO and MgO were each used instead of ZnO to obtain a solid ion conductor having a desired composition of Table 1.

### Comparative Example 8

Li_{5.4}PS_{4.4}Cl_{1.4}Br_{0.02} and ZnO of Comparative Example 1 were mixed to obtain a precursor mixture, which was used as a solid ion conductor. Here, the amount of ZnO was 2 parts by weight based on 100 parts by weight of the total weight of Li_{5.4}PS_{4.4}Cl_{1.4}Br_{0.2} and ZnO.

In the mixture obtained in Comparative Example 8, the Zn oxide is not substituted at the atomic position of the argyrodite structure and exists as an additional phase, preventing lithium ion conduction.

TABLE 1

| Division | Composition |
|---|---|
| Example 1 | Li_{5.36}Zn_{0.02}PS_{4.38}O_{0.02}Cl_{1.4}Br_{0.2} |
| Example 2 | Li_{5.3}Zn_{0.05}PS_{4.35}O_{0.05}Cl_{1.4}Br_{0.2} |
| Example 3 | Li_{5.2}Zn_{0.1}PS_{4.3}O_{0.1}Cl_{1.4}Br_{0.2} |
| Example 4 | Li_{5.36}Zn_{0.02}PS_{4.38}O_{0.02}Cl_{1.4}Br_{0.2} |
| Example 5 | Li_{5.36}Cd_{0.02}PS_{4.38}O_{0.02}Cl_{1.4}Br_{0.2} |
| Example 6 | Li_{5.36}Hg_{0.02}PS_{4.38}O_{0.02}Cl_{1.4}Br_{0.2} |
| Comparative Example 1 | Li₆PS₅Cl |
| Comparative Example 2 | Li_{5.96}Zn_{0.02}PS₅Cl |
| Comparative Example 3 | Li_{5.4}PS_{4.4}Cl_{1.4}Br_{0.2} |
| Comparative Example 4 | Li_{5.9}Zn_{0.05}PS_{4.95}O_{0.05}Cl_{0.5}Br_{0.5} |
| Comparative Example 5 | Li_{5.7}Zn_{0.15}PS_{4.85}O_{0.15}Br |
| Comparative Example 6 | Li_{5.3}Ca_{0.05}PS_{4.35}O_{0.05}Cl_{1.4}Br_{0.2} |
| Comparative Example 7 | Li_{5.3}Mg_{0.05}PS_{4.35}O_{0.05}Cl_{1.4}Br_{0.2} |
| Comparative Example 8 | Li_{5.4}PS_{4.4}Cl_{1.4}Br_{0.2} + Zn0 |

### Preparation Example 1

A positive electrode active material having a aLi₂O—ZrO₂ coating film was prepared according to the method disclosed in KR 10-2016-0064942, and was prepared according to the following method.

A mixed solution containing lithium methoxide, zirconium propoxide, ethanol, and ethyl acetoacetate was stirred and mixed for 30 minutes to prepare an alcohol solution (as a coating liquid for coating aLi₂O—ZrO₂) having a composition of aLi₂O—ZrO₂ (where a=1). Here, the amounts of lithium methoxide and zirconium propoxide were adjusted so that the amount of the aLi₂O—ZrO₂ (where a=1) coated on the surface of the positive electrode active material, LiNi_{0.8}Co_{0.15}Mn_{0.05}O₂ (NCM), was 0.5 mol %.

Next, the aLi₂O—ZrO₂ coating solution was mixed with fine powder of the positive electrode active material, LiNi_{0.8}Co_{0.15}Mn_{0.05}O₂ (NCM), and the mixed solution was heated to about 40° C. while stirring to dry the solvent by evaporation. Here, ultrasonic waves were irradiated to the mixed solution.

By carrying out the process above, a precursor of aLi₂O—ZrO₂ could be supported on the surface of particles of the fine powder of the positive electrode active material.

In addition, the precursor of aLi₂O—ZrO₂ (where a=1) supported on the surface of particles of the positive electrode active material was heat-treated at about 350° C. for 1 hour under an oxygen atmosphere. By the heat treatment process, the precursor of aLi₂O—ZrO₂ (where a=1) present on top of the positive electrode active material was changed to aLi₂O—ZrO₂ (where a=1). Here, the amount of Li₂O—ZrO₂ (LZO) was about 0.4 parts by weight based on 100 parts of NCM.

According to the preparation process described above, LiNi_{0.8}Co_{0.15}Mn_{0.05}O₂ (NCM) having an aLi₂O—ZrO₂ coating film was obtained. In aLi₂O—ZrO₂, a was 1.

(Preparation of All-Solid Battery)

Manufacture Example 1

(Positive Electrode Layer)

For use as a positive electrode active material, LiNi_{0.8}Co_{0.15}Mn_{0.05}O₂ (NCM) coated with Li₂O—ZrO₂ (LZO) of Preparation Example 1 was used.

For use as a solid electrolyte, powder of the solid ion conductor prepared in Example 1 was prepared. Also, a carbon nanofiber (CNF) was prepared as a conductive material. These materials, i.e., the positive electrode active material, the solid electrolyte, and the conductive material, were mixed at a weight ratio of 60:35:5 to form a mixture, which was then significantly molded into a sheet shape, so as to prepare a positive electrode sheet. The positive electrode sheet thus prepared was pressed onto a positive electrode current collector of an aluminum foil having a thickness of 18 μm and placed in a batch-type oil chamber. Then, a warm isostactic press process of applying a pressure of 500 MPa was performed thereon to prepare a compressed positive electrode layer. Here, the thickness of the positive electrode active material layer was about 100 μm.

(Negative Electrode Layer)

As a negative electrode current collector, an SUS foil (thickness: 10 μm) was prepared. For use as a negative electrode active material, silver (primary particle diameter: 60 nm) and carbon black powder (primary particle diameter: 35 nm) were mixed at a weight ratio of 25:75. In a container, based on a negative electrode layer, 7 wt % of N-methylpyrrolidone (NMP) was added together with the mixture of silver (primary particle diameter: 60 nm) and carbon black powder (primary particle diameter: 35 nm) and polyvinylidenefluoride as the binder, and the stirred to prepare a slurry for forming a negative electrode layer. The SUS foil was coated with the slurry for forming a negative electrode layer by using a blade coater, dried at 80° C. in the air for 20 minutes, and vacuum-dried at 100° C. for 12 hours to prepare a negative electrode layer.

(Solid EElectrolyte Layer)

For use as a solid electrolyte, the solid ion conductor of Example 1 was used, and, based on 100 parts by weight of the solid electrolyte, 1.5 parts by weight of an acryl-based resin was added as a binder to prepare a mixture. Isobutylisobutyrate (IBIB) was added to the mixture, and then, stirred to prepare a slurry. The slurry thus prepared was then applied onto a non-woven fabric by using a blade coater, and dried in the air at 25° C. to obtain a laminate. The laminate thus obtained was vacuum-dried at 40° C. for 12 hours. As such, a solid electrolyte layer was prepared by the process described above.

(Preparation of All-Solid Battery)

The solid electrolyte layer was arranged on one surface of the negative electrode layer, and the positive electrode layer was arranged on the solid electrolyte layer to prepare a laminate. Then, the laminate thus prepared was treated with a warm isostactic press for 30 minutes at 85° C. with a pressure of 500 MPa, so as to prepare an all-solid battery.

### Manufacture Examples 2 to 7

Each all-solid battery was prepared in the same manner as in Manufacture

Example 1, except that the solid ion conductor powder of each of Examples 2 to 7 was used as a solid electrolyte instead of the solid ion conductor powder of Example 1.

### Comparative Manufacture Examples 1 to 8

Each all-solid battery was prepared in the same manner as in Manufacture

Example 1, except that the solid ion conductor powder of each of Comparative Examples 1 to 3 was used as a solid electrolyte instead of the solid ion conductor powder of Example 1.

### Evaluation Example 1: Ionic Conductivity

200 mg of the powder of each of the solid ion conductors prepared in Examples 1 to 3 and Comparative Examples 1 to 3 was pressed at a pressure of 300 MPa and molded into a pellet having a diameter of about 13 mm. Indium (In) electrodes were placed on both surfaces of the pellet to prepare a symmetric cell for measuring ionic conductivity. For the prepared sample, impedance was measured by using an impedance analyzer

(Solartron 1470E multi-channel potentiostat) to show a Nyquist plot, from which the ionic conductivity was measured at 25° C.

Results of the ionic conductivity measurement are shown in Table 2.

TABLE 2

| | Ionic conductivity |
|---|---|
| Division | (mS/cm, 25° C.) |
| Example 1 | 6.53 |
| Example 2 | 6.93 |
| Example 3 | 6.81 |
| Example 6 | 5.9 |
| Comparative Example 1 | 2.78 |
| Comparative Example 2 | 2.76 |
| Comparative Example 3 | 6.45 |
| Comparative Example 4 | 2.01 |
| Comparative Example 5 | 1.45 |
| Comparative Example 6 | 3.94 |
| Comparative Example 7 | 1.94 |
| Comparative Example 8 | 2.81 |

As shown in Table 2, the solid ion conductors of Examples 1 to 3 had high ionic conductivity in a range of 6.53 mS/cm to 6.93 mS/cm compared to the solid ion conductors of Comparative Examples 1, 2, and 4 to 7, confirming suitability thereof as a solid electrolyte for an all-solid battery. The solid ion conductors of Examples 4 and 5 exhibited ionic conductivity similar to that of the solid ion conductor of Example 1.

Meanwhile, the solid ion conductor of Comparative Example 3 exhibited excellent ionic conductivity, but poor moisture stability, and thus is difficult to apply in practice. In addition, unlike the solid ion conductor of Example 1, the solid ion conductor of Comparative Example 8 exhibited low ionic conductivity by including an additional phase that hindered the conduction of lithium ions.

### Evaluation Example 2: XRD Analysis

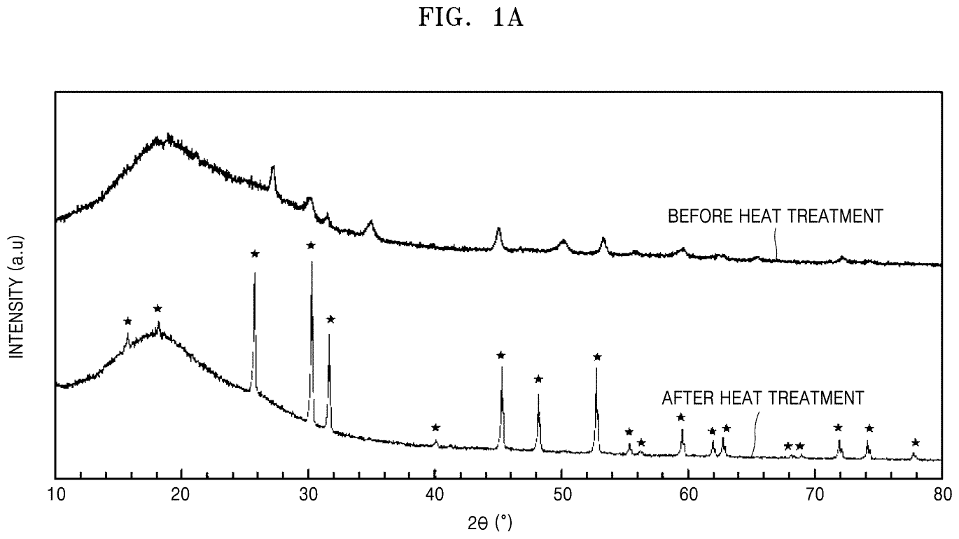

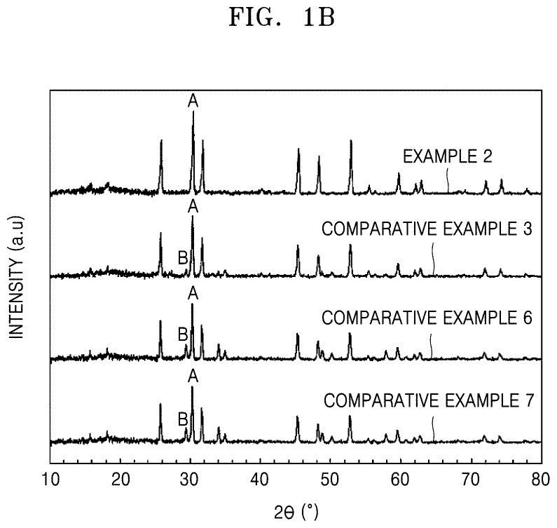

Powders of the solid ion conductor of Example 1 were prepared by pulverization by using an agate mortar, and then, an XRD spectrum of the powders was prepared, and results thereof are shown in FIG. 1A. Here, CuKa rays were used for the XRD analysis.

Referring to FIG. 1A, after performing heat treatment on the solid ion conductor of Example 1, argyrodite-related peaks were observed at 20 of 26°, 30°, 32°, 45°, 48°, and 53°.

In addition, the XRD analysis was performed on the solid ion conductors of

Example 2 and Comparative Examples 3, 6, and 7, and results thereof are shown in FIG. 1B and Table 3.

TABLE 3

| | | Argyrodite main | | Peak other than | | B/A |
|---|---|---|---|---|---|---|
| | | peak (A) | | argyrodite-related peak (B) | | Ratio of |
| Division | Composition | 2θ | intensity | 2θ | intensity | impurities |
| Example 2 | Li_{5.3}Zn_{0.05}PS_{4.35}O_{0.05}Cl_{1.4}Br_{0.2} | 30.42 | 2003.3 | 29.46 | 100.3 | 5.0% |
| Comparative | Li_{5.4}PS_{4.4}Cl_{1.4}Br_{0.2} | 30.30 | 1491.6 | 29.40 | 195.9 | 13.1% |
| Example 3 | | | | | | |
| Comparative | Li_{5.3}Ca_{0.05}PS_{4.35}O_{0.05}Cl_{1.4}Br_{0.2} | 30.24 | 1364.5 | 29.36 | 372.5 | 27.3% |
| Example 6 | | | | | | |
| Comparative | Li_{5.3}Mg_{0.05}PS_{4.35}O_{0.05}Cl_{1.4}Br_{0.2} | 30.24 | 1364.5 | 29.36 | 372.5 | 27.3% |
| Example 7 | | | | | | |

In Table 3, the impurity ratio (I_{B}/I_{A}) refers to a ratio of peak B intensity (I_{B}) to peak A intensity (I_{A}). The main peak having the greatest intensity among the argyrodite-related peaks was designated as Peak A, and the peak having the greatest intensity among the peaks other than the argyrodite-related peaks was designated as Peak B.

As shown in Table 3 and FIG. 1B, since the solid ion conductor of Example 2 had a crystal structure in which zinc was substituted into the crystal unlike the solid ion conductor of Comparative Example 3, a shift in the related peaks was observed as the unit cell size, i.e., lattice parameter, was changed. In detail, the main peak (2θ=30.42°) of the solid ion conductor of Example 2 corresponded to the main peak (2θ=30.30°) of the solid ion conductor of Comparative Example 3.

In addition, it was confirmed that the solid ion conductors of Example 2 and Comparative Examples 3, 6, and 7 had distinct impurity peaks. As shown in FIG. 1B, peaks related to the argyrodite crystal structure of the solid ion conductor of Example 2 were observed, wherein the main peak having the greatest intensity among the argyrodite-related peaks was indicated as Peak A, and the peak having the greatest intensity among the peaks other than the argyrodite-related peaks was indicated as Peak B. Here, the ratio (I_{B}/I_{A}) of peak B intensity (I_{B}) to peak A intensity (I_{A}) was less than 10%.

Meanwhile, in the solid ion conductors of Comparative Examples 6 and 7, the argyrodite-related peaks had low intensity and a considerable number of minor peaks appeared, resulting in a high impurity ratio.

### Evaluation Example 3: Particles Size Analysis and Scanning Electron Microscopy

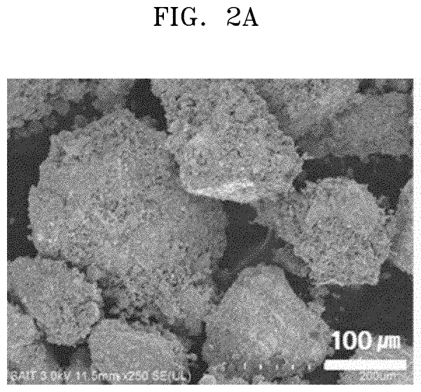

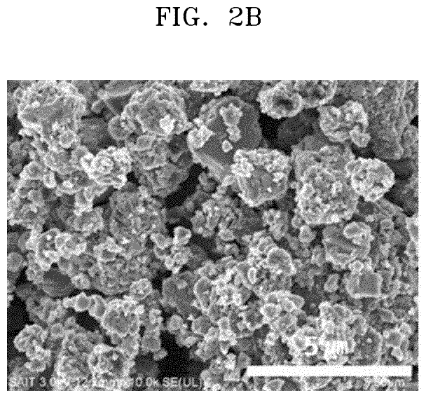

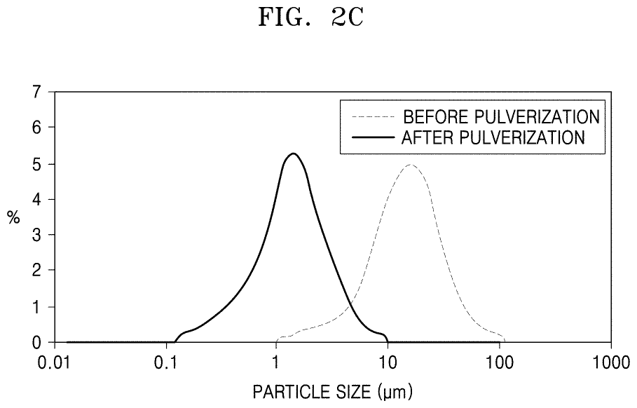

The powder of the solid ion conductor of Example 1 was mixed with xylene, and then ball-milled at about 150 rpm for 10 hours to 20 hours, and the particle size analysis on the resulting product was evaluated using a laser particle size analyzer (Bluewave, Microtrac). Scanning electron microscope images of the powder of the solid ion conductor, before and after the pulverization, are shown in FIGS. 2A and 2B. The analysis results are shown in FIG. 2C.

Referring to the figures, the solid ion conductor of Example 1 showed a uniform particle size distribution with an average particle diameter D50 of 2 mm.

### Evaluation Example 4: Evaluation of Moisture Stability

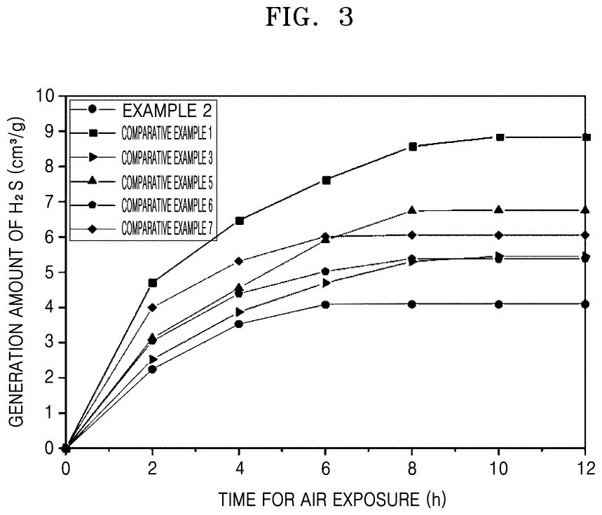

100 mg of the solid ion conductor of each of Examples 1 to 3 and Comparative Examples 1, 3, 5, 6, and 7 was prepared into a pellet having a diameter of 13 mm. The pellet was stored in a desiccator (16 L) in the atmosphere environments (temperature: 21° C., relative humidity 63%) for 12 hours, and then, the amount of hydrogen sulfide (H₂S) gas generated in the desiccator was measured during a time period of 0 hour to 12 hours. The generation amount of H₂S gas was measured after 10 hours. Results thereof are shown in Table 4, and some of the measured results are shown in FIG. 3.

TABLE 4

| | Amount of H₂S gas generated |
|---|---|
| Division | after 10 hours (cm³/g) |
| Example 1 | 4.4 |
| Example 2 | 4.3 |
| Example 3 | 4.1 |
| Comparative Example 1 | 8.8 |
| Comparative Example 3 | 5.5 |
| Comparative Example 5 | 6.8 |
| Comparative Example 6 | 5.4 |
| Comparative Example 7 | 6.1 |

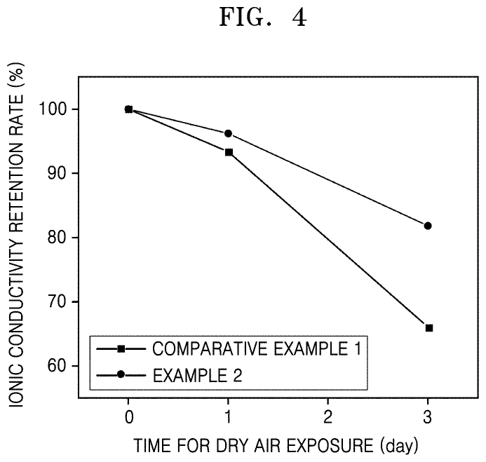

Referring to FIG. 4, it was confirmed that the solid ion conductors of Examples 1 to 3 had improved stability against moisture by introducing heterogeneous halogen elements, such as Cl and Br, and Zn so that the amount of H₂S gas generated by reactions of the element S with moisture in the crystal was significantly reduced compared to the solid ion conductors of Comparative Examples 1, 3, and 5 to 7.

In addition, as shown in FIG. 3, it was confirmed that the ratio of the H₂S gas generated after 300 minutes was reduced in the solid ion conductor of Example 2 compared to the ratio in the solid ion conductors of Comparative Examples 1, 3, 5, 6, and 7. Accordingly, it was confirmed that the solid ion conductor of Example 2 has improved moisture stability, thereby improving the material storability and processability in preparation.

### Evaluation Example 5: Dry Air Stability

After 500 mg of the solid ion conductor of each of Example 2 and Comparative

Example 1 was ball-milled using a pot mill so that the particle size D50 thereof was adjusted to 2 μm and 3 μm, changes in the ionic conductivity thereof was observed in a dry room environment (dew point temperature: −60 ° C.) while being stored therein for 3 days. Changes in the ionic conductivity of solid ion conductor in the case where the solid ion conductor was exposed to the dry room environment were also changed, and results thereof are shown in FIG. 4 and Table 5. The ionic conductivity retention rate in Table 5 was evaluated according to Equation 1:

Ionic conductivity retention rate={(ionic conductivity after exposure to dry air for 3 days)/(ionic conductivity before exposure to dry air)}×100 Equation 1

TABLE 5

| Division | Ionic conductivity retention rate (%) |
|---|---|
| Example 2 | 81.5 |
| Comparative Example 1 | 66.1 |

As shown in Table 4, it was confirmed that the ionic conductor of Example 2 had improved stability in the dry air by 23% or more compared to the solid ion conductor of Comparative Example 1 when stored in the dry room.

### Evaluation Example 6: Lithium Electrodepostion/Dissolution Characteristics

Each of the solid ion conductor of Examples 2 and 3 and Comparative Examples 1 and 2 was pulverized by using an agate mortar to prepare powder. Then, 200 mg of the powder was pressed at a pressure of 4 ton for 2 minutes to prepare a pellet specimen having a thickness of about 0.900 mm and a diameter of about 13 mm. A 40 μm-thick Li metal electrode was disposed on both surfaces of the prepared specimen, and then, pressurized with a pressure of 4 tons, so as to prepare a Li/Li symmetry cell. The preparation of the symmetry cell was carried out in a glove box in an Ar atmosphere.

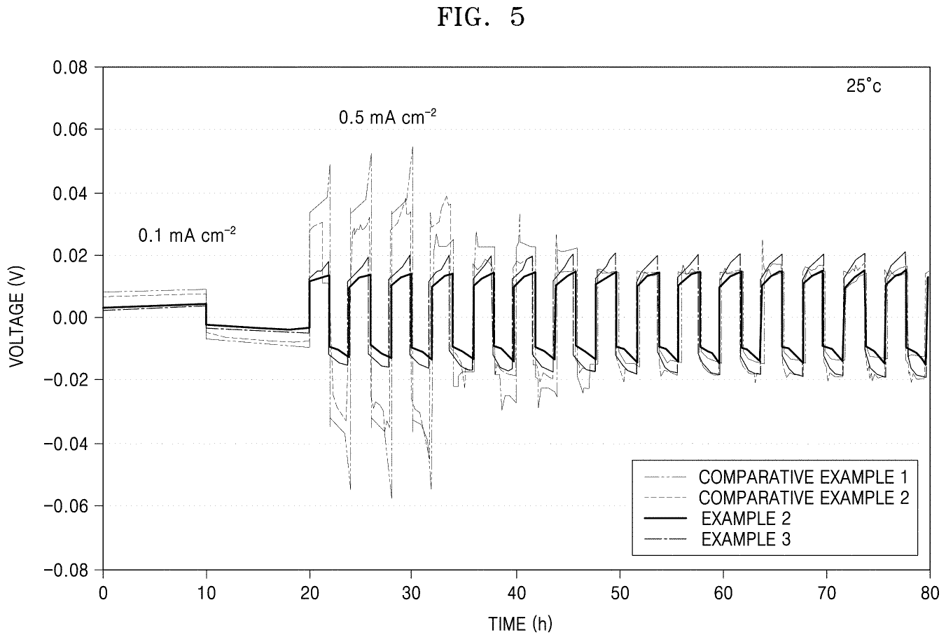

After charging and discharging once at 25° C. with a current of 0.1 mA cm⁻², charging and discharging were repeated with a current of 0.5 mA cm⁻² to evaluate Li electrodeposition/dissolution characteristics. Results thereof are shown in FIG. 5.

As shown in FIG. 5, when the solid ion conductors of Examples 2 and 3 were applied to a cell, unlike the solid ion conductors of Comparative Examples 1 and 2, a stable interface with lithium metal was formed due to Zn and oxygen included in the solid ion conductor, and thus, compared to Comparative Examples 1 and 2, the formation of Li dendrites was suppressed and stable lithium electrodeposition/dissolution behavior were observed.

However, in the case of Comparative Example 1, unstable lithium electrodeposition/dissolution behavior was observed.

### Evaluation Example 7: Charging/Discharging Characteristics

A torque cell was prepared according to the following procedure by using the solid ion conductors of Example 2 and Comparative Example 1.

(Preparation of Positive Electrode Layer)

For use as a positive electrode active material, LiNi_{0.8}Co_{0.15}Mn_{0.05}O₂ (NCM) coated with Li₂O—ZrO₂ (LZO) of Preparation Example 1 was used.

For use as a solid electrolyte, powder of the solid ion conductor prepared Example 1 was prepared. Also, a carbon nanofiber (CNF) was prepared as a conductive material. These materials, i.e., the positive electrode active material, the solid electrolyte, and the conductive material, were mixed at a weight ratio of 60:35:5 to prepare a positive electrode mixture.

(Preparation of Solid Electrolyte Powder)

The solid ion conductor compound prepared in Example 1 was pulverized by using an agate mortar to be prepared as a solid electrolyte powder.

(Preparation of Negative Electrode Layer)

For use as a negative electrode, a 30 μm-thick metal lithium foil was prepared.

(Preparation of All-Solid Secondary Battery)

On an SUS lower electrode, the negative electrode layer, 150 mg of the solid electrolyte powder, and 15 mg of the positive electrode mixture were sequentially stacked, and then, an SUS upper electrode was disposed on the positive electrode mixture to prepare a laminate, which was then pressurized with a pressure of 4 ton/cm² for 2 minutes. Subsequently, a torque of 4 N·m was applied with a torque wrench on the pressurized laminate, so as to prepare an all-solid secondary battery.

In a first cycle, charging was performed with a constant current of 0.1 C and a constant voltage of 4.25 V until the battery voltage reached 4.25 V and the current value reached 0.05 C. Next, discharging was performed with a constant current of 0.1 C until the battery voltage reached 2.5 V.

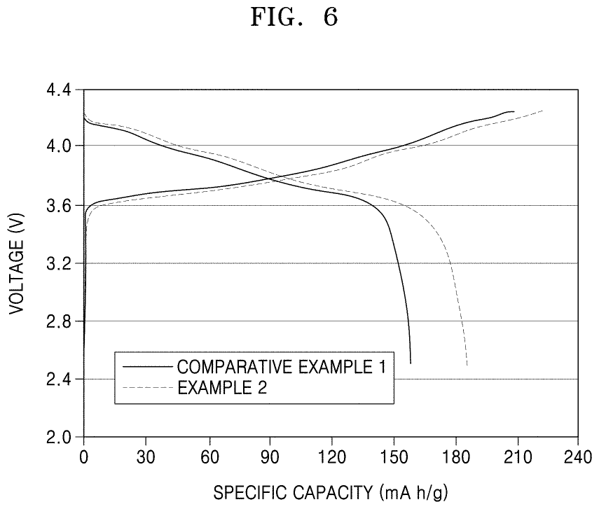

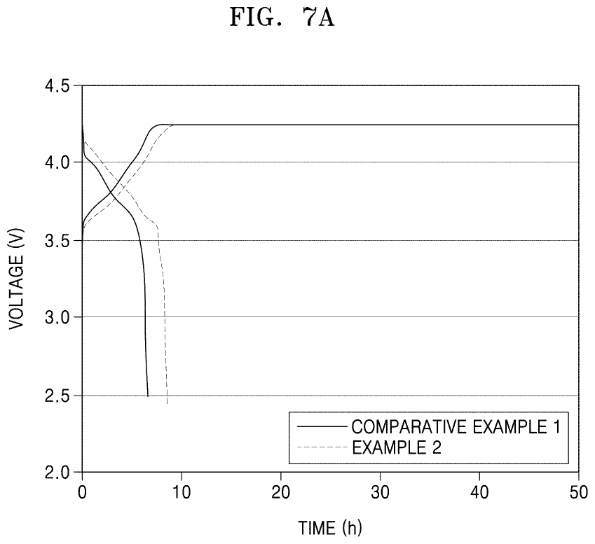

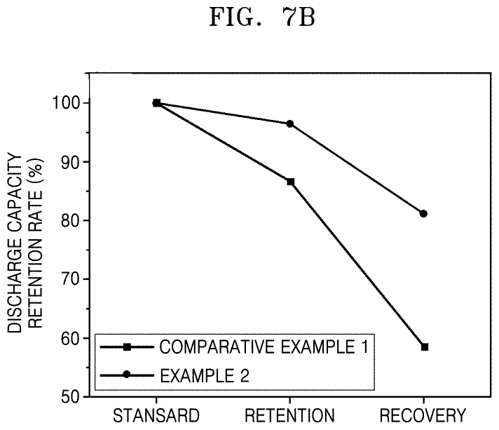

The charging and discharging behavior of each torque cell was evaluated, and results thereof are shown in FIG. 6 and Table 6.

TABLE 6

| | Charge | Discharge | |
|---|---|---|---|
| | capacity | capacity | Efficiency |
| Division | (mAh/g) | (mAh/g) | (%) |
| Example 2 | 221.9 | 185.0 | 83.4 |
| Comparative Example 1 | 207.7 | 158.3 | 76.2 |

Referring to FIG. 6 and Table 6, it was confirmed that the torque cell using the solid ion conductor of Example 2 exhibited higher discharge capacity than the torque cell using the solid ion conductor of Comparative Example 1 by 16% or more. Accordingly, it was confirmed that, based on the improved interfacial characteristics between the positive electrode and the electrolyte, the capacity and the charging and discharging efficiency of the battery were improved.

### Evaluation Example 8: High-Voltage Stability

In a first cycle for the torque cell of Comparative Example 7 using the solid ion conductor of each of Example 2 and Comparative Example 1, charging was performed with a constant current of 0.1 C and a constant voltage of 4.25 V until the battery voltage reached 4.25 V and the current value reached 0.05 C. Next, discharging was performed with a constant current of 0.1 C until the battery voltage reached 2.5 V.

Here, the discharge capacity in the first cycle was regarded as a standard capacity.

In a second cycle, charging was performed for 50 hours with a constant current of 0.1 C and a constant voltage of 4.25 V until the battery voltage reached 4.25 V. Next, discharging was performed with a constant current of 0.1 C until the battery voltage reached 2.5 V.

Here, the discharge capacity in the second cycle was regarded as a retention capacity.

In a third cycle, charging was performed with a constant current of 0.1 C and a constant voltage of 4.25 V until the battery voltage reached 4.25 V and the current value reached 0.05 C and the current value reached 0.05 C. Next, discharging was performed with a constant current of 0.1 C until the battery voltage reached 2.5 V.

Here, the discharge capacity in the third cycle was regarded as a recovery capacity.

For each cycle, there was a 10-minute rest period after the charging and discharging step.

TABLE 7

| | | Discharge | Capacity |
|---|---|---|---|
| | | capacity | retention rate |
| Storage at 45° C. for 50 hours | | (mAh/g) | (%) |
| Example 2 | Standard capacity | 185.0 | — |
| | Retention capacity | 178.5 | 96.0 |
| | Recovery capacity | 150.2 | 81.0 |
| Comparative | Standard capacity | 158.3 | — |
| Example 1 | Retention capacity | 137.2 | 87.0 |
| | Recovery capacity | 92.9 | 59.0 |

As shown in Table 7, the torque cell using the solid ion conductor of Comparative

Example 1 exhibited the retention and recovery rates of 87% and 59%, respectively, whereas the torque cell using the solid ion conductor of Example 2 exhibited the retention and recovery rates of 96% and 81%, respectively. Accordingly, in the case of Example 2, the positive electrode interface was stabilized, and thus the oxidation stability was improved. As a result, a cell having excellent high-voltage stability could be prepared. In addition, it was confirmed that the torque cell using the solid ion conductor of Example 2 exhibited a high capacity of 10% or more compared to the torque cell using the solid ion conductor of Comparative Example 1.

Meanwhile, in the case of Comparative Example 1, the charging and discharging and recovery rate characteristics were all degraded compared to the case of Example 2.

Hereinabove, the preferable embodiments of the present disclosure have been described with reference to drawings and Examples, but these are only exemplary, and those skilled in the art can understand that various modifications and equivalent other embodiments are possible therefrom. Therefore, the scope of protection of the present disclosure should be defined by the appended claims.

Explanation of Reference Numerals Designating the Major Elements of the Drawings

1, 1a: All-solid battery

10: Positive electrode

11: Positive electrode current collector

12: Positive electrode active material layer

20: Negative electrode

21: Negative electrode current collector

22: Negative electrode active material layer

23: Metal layer

30: Solid electrolyte layer

40: All-solid battery

1. A solid ion conductor represented by Formula 1 and having an argyrodite crystal structure:
Li_{7-2a-b-c}MₐPS_{6-a-b-c}OₐX1_{b}X2_{c} Formula 1
wherein, in Formula 1, M is zinc (Zn), cadmium (Cd), mercury (Hg), or a combination thereof,
wherein X1 and X2 are each independently chlorine (Cl), bromine (Br), iodine (I), a pseudohalogen, or a combination thereof, and
wherein 0<a<0.5, 0<b<2, 0<c<2, and 1<b+c<3.

2. The solid ion conductor of claim 1, wherein, in Formula 1, 0.02≤a≤0.1.

3. The solid ion conductor of claim 1, wherein X1_{b}X2_{c} is Cl_{b}Br_{c} or Cl_{b}I_{c}, and 0<b<2, 0<c<2, 1<b+c<3, and b>c.

4. The solid ion conductor of claim 1, wherein 1<b+c<2.

5. The solid ion conductor of claim 1, wherein 1≤b/c≤50.

6. The solid ion conductor of claim 1, wherein 1≤b/c≤20.

7. The solid ion conductor of claim 1, wherein, in Formula 1, M is Zn.

8. The solid ion conductor of claim 1, wherein a compound represented by Formula 1 is a compound represented by Formula 2:
Li_{7-2a-b-c}ZnₐPS_{6-a-b-c}OₐCl_{b}Br_{c} Formula 2
wherein, in Formula 2, 0<a<0.5, 0<b<2, 0<c<1, and 1≤b+c<2.

9. The solid ion conductor of claim 8, wherein b>c and 1≤b/c≤50.

10. The solid ion conductor of claim 1, wherein, in the solid ion conductor, a ratio of peak intensity (I_{B}) at a diffraction angle (2θ) of 29.07±0.5° to a peak intensity (I_{A}) at 2θ of 30.09°±0.5°, i.e., I_{B}/I_{A}, is <0.1 in an X-ray diffraction (XRD) spectrum using CuKα rays.

11. The solid ion conductor of claim 10, wherein I_{B}/I_{A}<0.07.

12. The solid ion conductor of claim 1, wherein 0.02≤a≤0.1, 1<b+c<2, b>c, and 1≤b/c≤20.

13. The solid ion conductor of claim 1, wherein the solid ion conductor is Li_{5.36}Zn_{0.02}PS_{4.38}O_{0.02}Cl_{1.4}Br_{0.2}, Li_{5.3}Zn_{0.05}PS_{4.35}O_{0.05}Cl_{1.4}Br_{0.2}, Li_{5.2}Zn_{0.1}PS_{4.3}O_{0.1}Cl_{1.4}Br_{0.2}, Li_{5.36}Zn_{0.02}PS_{4.38}O_{0.02}Cl_{1.2}Br_{0.4}, Li_{5.3}Zn_{0.05}PS_{4.35}_{0.05}Cl_{1.2}Br_{0.4}, Li_{5.2}Zn_{0.1}PS_{4.3}O_{0.1}Cl_{1.2}Br_{0.4}, Li_{5.36}Zn_{0.02}PS_{4.38}O_{0.02}Cl_{1.3}Br_{0.3,} Li_{5.3}Zn_{0.05}PS_{4.35}O_{0.05}Cl_{1.3}Br_{0.3}, Li_{5.2}Zn_{0.1}PS_{4.3}O_{0.1}Cl_{1.3}Br_{0.3}, Li_{5.36}Zn_{0.02}PS_{4.38}O_{0.02}Cl_{1.24}Br_{0.36}, Li_{5.3}Zn_{0.05}PS_{4.35}O_{0.05}Cl_{1.24}Br_{0.36}, Li_{5.2}Zn_{0.1}PS_{4.3}O_{0.1}Cl_{1.24}Br_{0.36}, Li_{5.36}Zn_{0.02}PS_{4.38}O_{0.02}Cl_{1.46}Br_{0.14}, Li_{5.3}Zn_{0.05}PS_{4.35}O_{0.05}Cl_{1.46}Br_{0.14}, Li_{5.2}Zn_{0.1}PS_{4.3}O_{0.1}Cl_{1.46}Br_{0.14}, Li_{5.36}Zn_{0.02}PS_{4.38}O_{0.02}Cl_{1.52}Br_{0.08}, Li_{5.3}Zn_{0.05}PS_{4.35}O_{0.05}Cl_{1.52}Br_{0.08}, Li_{5.2}Zn_{0.1}PS_{4.3}O_{0.1}Cl_{1.52}Br_{0.08}, Li_{5.26}Zn_{0.07}PS_{4.33}O_{0.07}Cl_{1.4}Br_{0.2}, Li_{5.56}Zn_{0.02}PS_{4.58}O_{0.02}Cl_{1.2}Br_{0.2}, Li_{5.5}Zn_{0.05}PS_{4.55}O_{0.05}Cl_{1.2}Br_{0.2}, Li_{5.46}Zn_{0.07}PS_{4.53}O_{0.07}Cl_{1.2}Br_{0.2}, Li_{5.4}Zn_{0.1}PS_{4.5}O_{0.1}Cl_{1.2}Br_{0.2}, Li_{5.66}Zn_{0.02}PS_{4.68}O_{0.02}Cl_{1.2}Br_{0.1}, Li_{5.6}Zn_{0.05}PS_{4.65}O_{0.05}Cl_{1.2}Br_{0.1}, Li_{5.56}Zn_{0.07}PS_{4.63}O_{0.07}Cl_{1.2}Br_{0.1}, Li_{5.5}Zn_{0.1}PS_{4.6}O_{0.1}Cl_{1.2}Br_{0.1}, Li_{5.76}Zn_{0.02}PS_{4.78}O_{0.02}Cl_{1.0}Br_{0.2}, Li_{5.7}Zn_{0.05}PS_{4.75}O_{0.05}Cl_{1.0}Br_{0.2}, Li_{5.66}Zn_{0.07}PS_{4.73}O_{0.07}Cl_{1.0}Br_{0.2}, Li_{5.6}Zn_{0.1}PS_{4.7}O_{0.1}Cl_{1.0}Br_{0.2}, Li_{5.36}Cd_{0.02}PS_{4.38}O_{0.02}Cl_{1.4}Br_{0.2}, Li_{5.3}Cd_{0.05}PS_{4.35}O_{0.05}Cl_{1.4}Br_{0.2}, Li_{5.2}Cd_{0.1}PS_{4.3}O_{0.1}Cl_{1.4}Br_{0.2}, Li_{5.36}Cd_{0.02}PS_{4.38}O_{0.02}Cl_{1.2}Br_{0.4}, Li_{5.3}Cd_{0.05}PS_{4.35}O_{0.05}Cl_{1.2}Br_{0.4}, Li_{5.2}Cd_{0.1}PS_{4.3}O_{0.1}Cl_{1.2}Br_{0.4}, Li_{5.36}Cd_{0.02}PS_{4.38}O_{0.02}Cl_{1.3}Br_{0.3}, Li_{5.3}Cd_{0.05}PS_{4.35}O_{0.05}Cl_{1.3}Br_{0.3}, Li_{5.2}Cd_{0.1}PS_{4.3}O_{0.1}Cl_{1.3}Br_{0.3}, Li_{5.36}Cd_{0.02}PS_{4.38}O_{0.02}Cl_{1.24}Br_{0.36,} Li_{5.3}Cd_{0.05}PS_{4.35}O_{0.05}Cl_{1.24}Br_{0.36}, Li_{5.2}Cd_{0.1}PS_{4.3}O_{0.1}Cl_{1.24}Br_{0.36}, Li_{5.36}Cd_{0.02}PS_{4.38}O_{0.02}Cl_{1.46}Br_{0.14}, Li_{5.3}Cd_{0.05}PS_{4.35}O_{0.05}Cl_{1.46}Br_{0.14}, Li_{5.2}Cd_{0.1}PS_{4.3}O_{0.1}Cl_{1.46}Br_{0.14}, Li_{5.36}Cd_{0.02}PS_{4.38}O_{0.02}Cl_{1.52}Br_{0.08}, Li_{5.3}Cd_{0.05}PS_{4.35}O_{0.05}Cl_{1.52}Br_{0.08}, Li_{5.2}Cd_{0.1}PS_{4.3}O_{0.1}Cl_{1.52}Br_{0.08}, Li_{5.36}Hg_{0.02}PS_{4.38}O_{0.02}Cl_{1.4}Br_{0.2}, Li_{5.3}Hg_{0.05}PS_{4.35}O_{0.05}Cl_{1.4}Br_{0.2}, Li_{5.2}Hg_{0.1}PS_{4.3}O_{0.1}Cl_{1.4}Br_{0.2}, Li_{5.36}Hg_{0.02}PS_{4.38}O_{0.02}Cl_{1.2}Br_{0.4}, Li_{5.3}Hg_{0.05}PS_{4.35}O_{0.05}Cl_{1.2}Br_{0.4}, Li_{5.2}Hg_{0.1}PS_{4.3}O_{0.1}Cl_{1.2}Br_{0.4}, Li_{5.36}Hg_{0.02}PS_{4.38}O_{0.02}Cl_{1.3}Br_{0.3}, Li_{5.3}Hg_{0.05}PS_{4.35}O_{0.05}Cl_{1.3}Br_{0.3}, Li_{5.2}Hg_{0.1}PS_{4.3}O_{0.1}Cl_{1.3}Br_{0.3}, Li_{5.36}Hg_{0.02}PS_{4.38}O_{0.02}Cl_{1.24}Br_{0.36}, Li_{5.3}Hg_{0.05}PS_{4.35}O_{0.05}Cl_{1.24}Br_{0.36}, Li_{5.2}Hg_{0.1}PS_{4.3}O_{0.1}Cl_{1.24}Br_{0.36}, Li_{5.36}Hg_{0.02}PS_{4.38}O_{0.02}Cl_{1.46}Br_{0.14}, Li_{5.3}Hg_{0.05}PS_{4.35}O_{0.05}Cl_{1.46}Br_{0.14}, Li_{5.2}Hg_{0.1}PS_{4.3}O_{0.1}Cl_{1.46}Br_{0.14}, Li_{5.36}Hg_{0.02}PS_{4.38}O_{0.02}Cl_{1.52}Br_{0.08}, Li_{5.3}Hg_{0.05}PS_{4.35}O_{0.05}Cl_{1.52}Br_{0.08}, Li_{5.2}Hg_{0.1}PS_{4.3}O_{0.1}Cl_{1.52}Br_{0.08}, or a combination thereof.

14. The solid ion conductor of claim 1, wherein an ionic conductivity of the solid ion conductor represented by Formula 1 at 25° C. is 3.0 mS/cm or more.

15. The solid ion conductor of claim 1, wherein an ionic conductivity retention rate of the solid ion conductor is 70% or more after 10 days under dry conditions in an air atmosphere having a dew point of less than −60° C.

16. The solid ion conductor of claim 1, wherein, when the solid ion conductor is exposed to the atmosphere, an amount of H₂S generated is less than 5 cm³/g.

17. A solid electrolyte comprising the solid ion conductor of claim 1.

18. An electrochemical cell, comprising:
a positive electrode layer including a positive electrode active material layer;
a negative electrode layer including a negative electrode active material layer; and
an electrolyte layer between the positive electrode layer and the negative electrode layer,
wherein at least one of the positive electrode layer, the negative electrode layer, and the electrolyte layer includes the solid ion conductor of claim 1.

19. The electrochemical cell of claim 18, wherein an average particle diameter of the solid ion conductor is 2 μm or less.

20. The electrochemical cell of claim 18, wherein the positive electrode layer includes the solid ion conductor, and an amount of the solid ion conductor is in a range of 2 parts by weight to 70 parts by weight based on 100 parts by weight of a total weight of the positive electrode layer.

21. The electrochemical cell of claim 18, wherein the electrochemical cell is an all-solid battery.

22. The electrochemical cell of claim 18, wherein the negative electrode layer includes:
a negative electrode current collector; and
a first negative electrode active material layer including a negative electrode active material, disposed on the negative electrode current collector, and the negative electrode active material including at least one of a carbon-based negative electrode active material and a metal or metalloid negative electrode active material.

23. The electrochemical cell of claim 22, wherein the carbon-based negative electrode active material includes at least one of amorphous carbon and crystalline carbon.

24. The electrochemical cell of claim 22, wherein the metal or metalloid negative electrode active material includes at least one of gold (Au), platinum (Pt), palladium (Pd), silicon (Si), silver (Ag), aluminum (Al), bismuth (Bi), tin (Sn), and zinc (Zn).

25. The electrochemical cell of claim 22, further comprising a second negative electrode active material layer between the negative electrode current collector and the first negative electrode active material layer and/or between the electrolyte layer and the first negative electrode active material layer, and
the second negative electrode active material layer is a metal layer including lithium or a lithium alloy.

26. The electrochemical cell of claim 18, wherein a capacity retention rate of the electrochemical cell is 80% or more at a 100th cycle after charging and discharging with 4 V or more in a thermostatic bath at 25° C.

27. The electrochemical cell of claim 18, wherein the positive electrode layer includes a positive electrode active material, and the positive electrode active material is at least one of a lithium transition metal oxide having a layered crystal structure, a lithium transition metal oxide having an olivine crystal structure, and a lithium transition metal oxide having a spinel crystal structure.

28. A method of preparing a solid ion conductor, the method comprising:
providing a mixture by bringing a lithium precursor, a metal (M) precursor, a phosphorus (P) precursor, and a halogen precursor into contact with each other; and
providing a solid ion conductor by performing heat treatment on the mixture in an inert atmosphere, to thereby prepare the solid ion conductor of claim 1.

29. The method of claim 28, wherein the heat treatment is performed at a temperature in a range of 400° C. to 700° C.
